(19) United States
(12) Patent Application Publication
(10) Pub. No.: US 2025/0377650 A1
(43) Pub. Date: Dec. 11, 2025

(54) ENHANCED OFF-LINE FIELD DEVICE INTEGRATION SYSTEM

(71) Applicant: Fieldcomm Group, Inc., Austin, TX (US)

(72) Inventors: Achim Laubenstein, Löhne (DE); Robert Michael Weinberger, Prior Lake, MN (US); Sean Vincent, Austin, TX (US); Mathias Maurmaier, Karlsruhe (DE); Andreas Isenmann, Haslach I.k. (DE); Shanthala Kamath, Bothell, WA (US); Daniel Grossman, Ingolstadt (DE); Emanuel Kolb, Gorxheimertal (DE); Tim Johnston, Austin, TX (US)

(21) Appl. No.: 18/740,147

(22) Filed: Jun. 11, 2024

Related U.S. Application Data
(60) Provisional application No. 63/472,416, filed on Jun. 12, 2023.

(51) Int. Cl. G05B 19/418

(52) U.S. Cl. CPC G05B 19/41835; G05B 2219/31368

(57) ABSTRACT

A field device integration (FDI) system is configured to support the use of OPC UA, OPC UA FX and other flexible (or open) information model based communication protocols in an FDI environment or with an FDI host in a manner that enables the FDI host to fully integrate the support of OPC UA devices with other devices, including other devices that do and that do not support the OPC UA communication protocol. The FDI system design reduces FDI package configuration activities for the OPC UA devices and optimizes the use of the OPC UA data models developed for the OPC UA device within the FDI environment. Still further, the FDI system enables an FDI host to support device communications in both an on-line environment, in which the devices are communicatively connected to the FDI host while operating on-line in a process or factory environment, and in an off-line environment, in which the FDI system simulates or models the operation of a device that is not currently communicatively connected to the FDI host.

### RELATED APPLICATIONS

This application claims priority to and the benefit of the filing date of U.S. Provisional Patent Application No. 63/472,416, filed on Jun. 12, 2023, entitled “Optimizing a Field Device Integration System to use a Data Communication Mapping Standard,” the entire disclosure of which is hereby expressly incorporated by reference herein.

### FIELD OF THE DISCLOSURE

The present disclosure generally relates to industrial plants, automation plants, and control systems and, more particularly, to providing a field device integration management system that supports field devices using a standardized data communication mapping or information model.

### BACKGROUND

Control systems, like those used in chemical, petroleum, industrial, manufacturing, packaging, assembling, and/or other industrial process or automation plants to manufacture, refine, transform, generate, package, or produce physical materials or products typically include one or more controllers communicatively coupled to one or more field devices. In larger control systems, the controllers and field devices can be communicatively coupled via analog, digital or combined analog/digital buses and/or via a wireless communication link or network. The field devices, which may be, for example, valves, valve positioners, actuators, variable speed drives, motor controllers, switches, and transmitters (e.g., temperature, pressure, level and flow rate sensors), are located within the plant environment (also interchangeably referred to herein as the field environment of the plant) and generally functionally perform physical or process control functions such as opening or closing valves, measuring process and/or environmental parameters such as temperature or pressure, etc. to control one or more processes or machines executing within the plant or system. Smart field devices, such as the field devices conforming to the well-known FOUNDATION® Fieldbus protocol HART, PROFINET PROFIBUS, Ethernet/IP, OPC UA protocol or other suitable industrial automation protocols may also functionally perform control calculations, alarming functions, and other control functions commonly implemented within the controller. The controllers, which may or may not be located within the field environment of the plant, receive signals indicative of measurements made by the field devices and/or other information pertaining to the field devices and execute a controller application that runs, for example, different control modules which make control decisions, generate control signals based on the received information and coordinate with the control modules or blocks being performed in the field devices by utilizing 4-20 mA analog signals, HART®, WirelessHART®, HART-IP®, FOUNDATION® Fieldbus, OPC UA, UPC UAFX compatible, and/or other industrial communication protocols or non-process control protocols, such as http, ftp, any Ethernet based system, etc. The control modules in the controller can send the control signals over the communication lines or links to the field devices to thereby control the operation of at least a portion of the plant or system, e.g., to control at least a portion of one or more industrial processes or machines running or executing within the plant or system. I/O devices, which are also typically located within the field environment, are usually disposed between a controller and one or more field devices, and enable communications there between, e.g., by converting electrical signals into digital values and vice versa. As utilized herein, field devices, controllers, and I/O devices are generally referred to as “control devices” or “automation devices.” Generally, but not necessarily, field device, I/O devices, and at least some controllers may be physically located, disposed, or installed in a field environment of a process or automation plant.

Information from the field devices and the controllers can be made available over a data highway or communication network to one or more other hardware devices, such as operator workstations, personal computers or centralized computing devices, data historians, report generators, centralized databases, device management tools (which can be located centrally or in a decentralized manner) with respect to a control room such as in the field), asset management tools, engineering tools, maintenance and optimization tools, or other centralized or decentralized administrative computing devices that are typically placed in control rooms or other locations away from the harsher field environment of the plant, e.g., in a back-end environment of the plant, in the cloud, etc. These hardware devices, which may be centralized across the plant or across a portion of the plant, run applications that may, for example, enable an operator to perform user functions with respect to controlling an industrial or automation process and/or operating the plant, such as changing settings of the process control routine, modifying the operation of the control modules within the controllers or the field devices, viewing the current state of the process or plant, viewing alarms generated by field devices and controllers, simulating the operation of the process for the purpose of training personnel or testing the control software, keeping and updating a configuration database, etc. The data highway utilized by the hardware devices, controllers and field devices may include a wired communication path, a wireless communication path, or a combination of wired and wireless communication paths.

As an example, a distributed process control system (DCS) may include multiple applications stored within and executed by different devices located at diverse places within a process plant. A configuration application, which resides in one or more workstations or computing devices in a back-end environment of a process control system or plant, enables users to create or change process control modules and download these process control modules via a data highway to dedicated distributed controllers. Typically, these control modules are made up of communicatively interconnected function blocks, which may be objects in an object oriented programming protocol that perform functions within the control scheme based on inputs thereto and that provide outputs to other function blocks within the control scheme. The configuration application may also allow a configuration designer to create or change operator interfaces which are used by a viewing application to display data to an operator and to enable the operator to change settings, such as set points, within the process control routines. Each dedicated controller and, in some cases, one or more field devices, stores and executes a respective controller application that runs the control modules assigned and downloaded thereto to implement actual process control functionality. The viewing applications, which may be executed on one or more operator workstations (or on one or more remote computing devices in communicative connection with the operator workstations and the data highway), receive data from the controller application via the data highway and display this data to process control system designers, operators, or users using the user interfaces, and may provide any of a number of different views, such as an operator's view, an engineer's view, a technician's view, etc. A data historian application is typically stored in and executed by a data historian device that collects and stores some or all of the data provided across the data highway while a configuration database application may run in a still further computer attached to the data highway to store the current process control routine configuration and data associated therewith. Alternatively, the configuration database may be located in the same workstation as the configuration application. As another example, PLC control system use logic controllers disposed in a plant to perform control and may communicate with more centralized support devices.

Still further, industrial and other control systems typically include asset management tools and device management tools including handheld devices, which are used to connect with, configure, read, diagnose, and otherwise manage field devices. These asset and device management tools may connect to databases and other control system computers to receive new information to use in managing field devices and to provide data from the field devices to the system computers for use in various manners.

FDI (Field Device Integration) is a technology standard for integrating and managing field devices, such as sensors, actuators and/or any other types of field devices, in industrial automation and control systems. Generally speaking, FDI provides a unified approach to integrating devices from different vendors or manufacturers, reducing the time and effort required for configuration, maintenance, and diagnosis of field devices within a plant or factory. As is known, FDI defines a device package, called an FDI device package or device package, which includes one or more device descriptors using a standardized device description language and/or device specific software application(s) that provide a comprehensive and consistent representation of the capabilities, functions, and parameters of the field devices. FDI device packages can be created by device vendors or manufacturers using standard tools and methods, and can be imported and used by different engineering and configuration tools. FDI also includes an architecture defining a client/server system as well as communication servers referred to herein as an “FDI host” or an “FDI management tool,” that provides a unified and user-friendly environment for integrating, configuring, and diagnosing field devices using FDI packages. The FDI host or management tool generally supports one or more of a set of different communication protocols, such as HART, FOUNDATION Fieldbus, PROFIBUS, PROFINET, Ethernet/IP, OPC UA and others, and provides a consistent and standardized way of accessing and managing device information from devices that uses these communication protocols. Overall, FDI simplifies the integration and management of field devices in industrial automation and control systems, reducing the complexity and cost of system design, implementation, and maintenance, and improving the efficiency and reliability of the system operation.

A significant benefit of FDI technology is that it enables devices, such as field devices, switches, PLCs, Gateways, etc. which are produced by different manufacturers to be easily integrated into any type of industrial process or automation system, asset management system, device management system, engineering tool, etc., thereby providing ease of field device administration and management in industrial process and automation plants. To support FDI capabilities, a device manufacturer or other originating party creates an FDI device package corresponding to a field device or other type of device. Here, the FDI device package includes a device descriptor of some sort and optionally can include user interface plug-ins, device applications, integration files, documentation, and other types of attachments. The device package originator can submit the FDI device package to a FDI Registration Authority (RA) for testing and verification. After performing and passing significant conformance testing, the FDI RA issues a conformance certificate or other suitable security credential for the verified FDI device package and the verified FDI device package is registered with the FDI RA. The originator or creator of the FDI device package can then store or load instances of the registered FDI device package into field devices. Upon the initiation of the integration of such a field device into the field environment of a process or automation plant, an FDI host of the plant verifies the authenticity of the registered FDI device package stored at the field device, e.g., based on the certificate securing the FDI device package. Upon successful verification of the FDI device package, the FDI host or management tool imports the registered FDI device package from the field device into the FDI host so that data and process values related to the field device can be easily described (e.g., as per the device description included in the FDI device package) to other devices and systems of different configurations and platforms, some of which may use communication interfaces and protocols different than those utilized by the field device.

FDI hosts or management tools may be implemented in an on-line or in an off-line environment at the plant in a control system (such as a DCS) or a Programmable Logic Control (PLC) system, and in systems or independent applications outside of a control system such as asset management system (AMS), a configuration tool, and the like, each of which is typically located within the firewalls and confines of other cybersecurity systems and mechanisms protecting the plant. An FDI host may include a communication server which can provide communication interfaces to the process control system, to devices and/or to field communication systems, as well as provide secured communication interfaces to enterprise and external systems outside of the plant's cybersecurity walls. As noted above, the communication server of the FDI host can implement various industrial communications protocols such as Profibus, PROFINET, Ethernet/IP, Foundation Fieldbus, HART, WirelessHART, HART-IP, OPC UA, and the like and, in some cases, various general-purpose communications protocols such as IP and/or other types of packet protocols. As such, FDI systems can provide secure interoperability between different devices and/or systems which are located within the secured process plant, as well as provide secure interoperability between field devices and other devices and/or

OPC UA (Open Platform Communications Unified Architecture) is a standardized communication protocol used in industrial automation and control systems that enables devices (e.g., field devices and controllers) to share data and information (using a standardized communication model) in a secure, reliable, and platform-independent way, enabling interoperability between different systems and vendors. In addition to communication functions, OPC UA also provides a flexible data modeling framework (referred to herein as a data or information model) that enables the representation of complex data structures, and it supports a variety of communication mechanisms, including TCP/IP, HTTPS, and MQTT. OPC UA also includes built-in security features such as encryption, authentication, and authorization, which help protect the integrity and confidentiality of the data being exchanged. Overall, OPC UA simplifies the integration and interoperability of different systems in industrial applications by mapping device parameters from various different devices into a common data or information model.

Generally speaking, OPC UA is a client-server architecture that uses a layered approach to provide a flexible and scalable framework for communication between field devices and controllers and other system computers. The layers of the OPC UA architecture include (1) the Application layer, where data and information are exchanged between client and server applications, using an abstract information model that defines the structure and semantics of the data, (2) the Session layer, where the client and server establish a secure session to exchange data and information, including authentication, encryption, and access control, (3) the transport layer, where the data is transmitted over a network using one of a variety of communication protocols such as TCP/IP, HTTPS, and MQTT, ensuring reliable delivery and message integrity, and (4) the Network layer, where the physical network infrastructure and topology are defined and managed, providing connectivity between field devices and other system components.

OPC UA also includes a set of standard services that define the functionality and behavior of the client and server applications and that enable or instruct a user interface to operate consistently to perform activities, such as browsing, reading, writing, and subscribing to data. Additionally, as noted above, OPC UA includes a flexible data or information model that enables the representation of complex data structures, making it easier for different systems to share and interpret data accurately. The OPC UA data model is a flexible and extensible framework that provides a standardized way of representing data and information exchanged between machines and devices in industrial automation and control systems. As such, the device manufacturer that enables a device to use OPC UA must create or establish a data model for the device to map to the OPC UA communication structure.

As noted above, FDI systems are generally developed for and used with field devices that have been designed and manufactured to support and to communicate using one of a set of known process control communication protocols, such as HART, WirelessHART, FOUNDATION Fieldbus, Profibus, etc. and for which a manufacturer provides an FDI device or other FDI package to enable the FDI management tool or host to receive and interpret data from different devices using the standardized process control communication protocol. Importantly, the device manufacturer must expend a significant effort to create the FDI package for a field device to include a data model that models the device operation, as well as to provide user interface instructions for interfacing with the device. While FDI systems can be used to support devices or systems that use a flexible object data model to map variables, parameters, etc. from various different devices, such as the OPC UA communication protocol, doing so still requires the device manufacturer to create an FDI package including a separate data model for use by the FDI host, and for use in performing user interface operations with the OPC UA device.

### SUMMARY

Systems and methods are described herein which support the use of OPC UA and OPC UAFX and other flexible (or open) data model communication protocols in an FDI environment or with an FDI host in a manner that enables the FDI host to fully integrate OPC devices, in a manner the reduces FDI package configuration activities for the OPC UA and OPC UAFX devices and in a manner that optimizes the use of the OPC UA and OPC UAFX data models developed for the OPC UA and OPC UAFX devices within the FDI environment. Still further, these systems and methods enable an FDI host to support field device communications in both an on-line environment, in which the field devices are communicatively connected to the FDI host while operating on-line in a process environment, and in an off-line environment, in which the FDI host simulates or models the operation of a field device that is not currently communicatively connected to the FDI host.

Generally speaking, these systems and methods may be used to implement support of devices in, for example, industrial and factory plants, environments, and/or control systems, which are interchangeably referred to herein as “process control,” “control,” or “process” systems, environments, and/or plants. Some of such systems and plants can provide control, e.g., in a distributed manner, of one or more processes that operate to manufacture, refine, or transform, raw physical materials to generate or produce physical products (e.g., “industrial processes”). Others of such systems and plants can provide control, e.g., in a distributed manner, of one or more processes that operate to provide automation, such as packaging, assembly, printing, machining, and/or other factory automation processes.

Generally speaking, the techniques described herein leverage OPC UA and OPC UAFX device and user interface models within the Field Device Integration (FDI) environment in a manner that reduces the development activities needed to create an FDI package for an OPC UA or OPC UAFX device and that enables the FDI host to provide consistent on-line and/or off-line support for OPC supported devices in a process plant.

### BRIEF DESCRIPTION OF THE DRAWINGS

FIG. 1 depicts a traditional FDI host that provides both on-line and off-line support of a field device incorporating OPC UA technology within the FDI host.

FIG. 2A depicts a generalized FDI system that uses a separate FDI package and an FDI host, which provide enhanced on-line and off-line support of devices by implementing a standardized way to store, import, and export device configuration data.

FIG. 2B depicts a generalized FDI system of FIG. 2A in which portions of the FDI package are provided by a device, such as a field device.

FIG. 3 depicts a first FDI system in an on-line environment in which an FDI host communicates with a device using an OPC UA communication structure and information model to perform user interface functions with respect to the field device.

FIG. 4 depicts the FDI system of FIG. 3 in which an FDI host includes or communicates with an off-line device representation of a field device using an OPC UA communication structure and information model, wherein the offline device representation uses an off-line device model and a UI model provided by via an FDI package.

FIG. 5 depicts a second FDI system in an on-line environment in which the FDI host communicates with an OPC UA supported field device using both a web server and an OPC UA communication structure and information model to perform user interface functions with respect to the field device, without the need of a separate device model.

FIG. 6 depicts the second FDI system of FIG. 5 in which the FDI host communicates with an off-line device representation of an OPC UA supported field device using both a web server and an OPC UA communication structure and information model, wherein the off-line device representation uses an off-line device model and a UI model provided by an FDI package.

FIG. 7 depicts a third FDI system in an on-line environment in which an FDI host communicates with an OPC UA supported field device using a tiered web server and an OPC UA client/server communication structure to perform user interface functions with respect to the field device without the use of a separate device model.

FIG. 8 depicts the third FDI system of FIG. 7 in which the FDI host communicates with an off-line representation of a field device using a tiered web server and an OPC UA communication client/server communication structure, wherein the off-line device representation uses an off-line device model and a UI model provided by an FDI package.

FIG. 9 depicts a fourth FDI system in an on-line environment in which an FDI host communicates with a device representation of a field device using a first OPC UA server for the purpose of performing user interface functions and communicates with an on-line field device using a second OPC UA server to communicate device data.

FIG. 10 depicts the fourth FDI system of FIG. 9 in which an FDI host communicates with an off-line device representation of a field device using two separate OPC UA servers, including using a first OPC UA server for performing user interface functions and a second OPC UA server for communicating with a simulated device, wherein the off-line device representation uses an off-line device model and a UI model provided by an FDI package.

### DETAILED DESCRIPTION

A Field Device Integration (FDI) system is described herein that includes a unique architecture configured to support more advanced field devices, such as those that use advanced communication protocols and information models that incorporate parameter, data or information mapping models, such as OPC UA and OPC UAFX. While the FDI systems described herein are specifically described as having architectures that use or support the OPC UA and OPC UAFX communication model and information model to enable support of field devices that incorporate OPC UA and OPC UAFX communication model and information models, the FDI systems described herein may use the same principles, techniques and architectures to support other advanced communication parameter mapping protocols and to support field devices that use those protocols, including those that use server/client communication architectures or other communication architectures. Moreover, as will be understood, the FDI systems described herein may be implemented in plants which operate to implement one or more industrial processes or may be implemented in other automation systems, such as those used in factory automation.

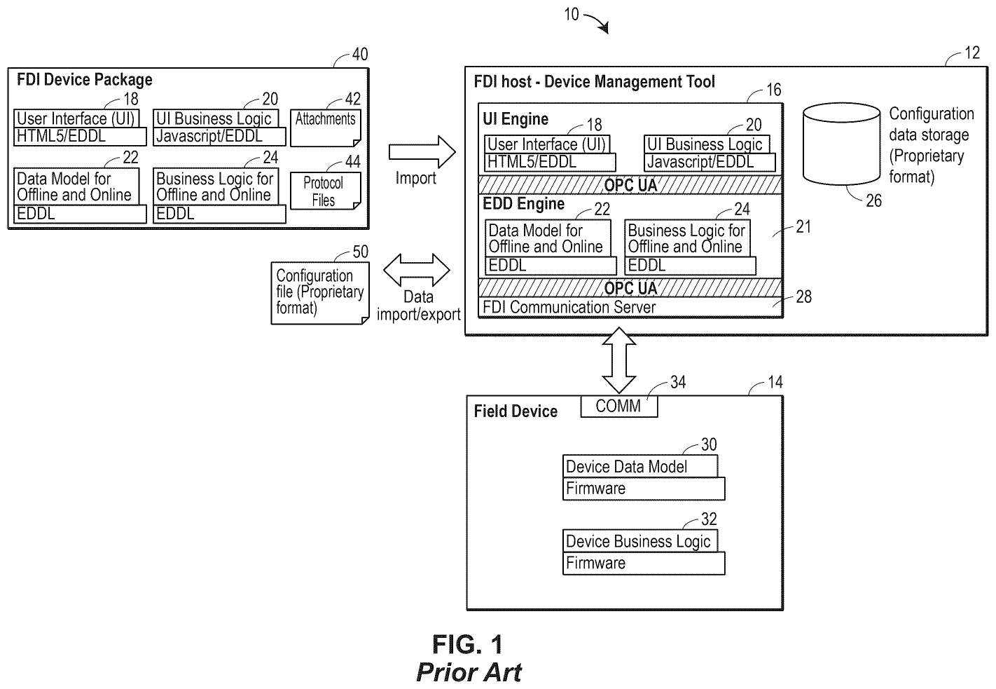

Prior to describing the manner in which the new FDI system described herein operates to support OPC UA and OPC UAFX compatible field devices, it is beneficial to describe the manner in which FDI currently uses OPC UA within an FDI host to support field devices that do not themselves support OPC UA communications to understand the later described architecture. In particular, FIG. 1 depicts an example of a typical FDI system 10 including an FDI host 12 connected to one or more field devices 14 in which the FDI host 12 uses an internal OPC UA client/server and an FDI communication server structure to support the field devices 14, which use a common process control communication protocol, such as the FOUNDATION® Fieldbus protocol, the HART® protocol, the Profibus protocol, etc. In this case, the FDI host 12 includes a user interface (UI) engine 16 that includes a UI interface application or programming 18 and a set of UI business logic 20 that operate together to perform UI functions at the FDI host 12 to thereby enable a user to perform UI functions with respect to the field device 14. Additionally, the FDI host 12 includes a device engine 21 for the field device 14 that includes a device data model 22 and a set of business logic 24 for the field device 14. The FDI host 12 also includes a configuration data storage or memory 26 that stores configuration data, etc. for the FDI host 12, typically in a proprietary format. The FDI host 12 also includes an FDI communication server 28 which communicates with the field device 14 using, for example, a process control communication protocol, such as the FOUNDATION Fieldbus, the HART, the Profibus, etc. communication protocol.

Likewise, as illustrated in FIG. 1, the field device 14 includes a device data model 30 and a set of device business logic 32 which the field device 14 uses to operate, with the data model 30 and the device business logic 32 being stored and implemented in device firmware, typically in a proprietary manner. The field device 14 also includes a communication interface 34 which communicates using a process control protocol, such as Fieldbus, HART, etc., with external devices, such as the FDI host 12 (but which could include other devices). The device data model 30 and the device business logic 32 are typically proprietary in nature and are created and provided by the field device manufacturer of the field device 14 and, in this case, are illustrated as being implemented in device firmware.

As illustrated in FIG. 1, a user may import an FDI device package 40, which may be a separate file, into the FDI host 12, and the FDI host 12 uses the FDI device package 40 to communicate with and support the field device 14 in both an on-line and an off-line manner. As will be understood, the FDI device package 40 includes a set of user interface instructions 18, the UI business logic 20, a device data model for off-line and on-line operation 22 and device business logic 24 for off-line and on-line operation. The FDI package 240 may also include one or more attachments or files 42 and one or more protocol specific files 44 used to import the FDI device package 40 into the FDI host 12. Prior to operation of the FDI host 12, the FDI package 40 is provided to the FDI host 12 for use in supporting the field device 14. In this case, the UI instructions 18 and the UI business logic 20 are provided to the UI engine 16 of the FDI host 12. Likewise, the on-line and off-line device engine files, including the device data model 22 and the device business logic 24 are provided to the device engine 21, which is a device simulation engine that simulates operation of the field device 14 using the provided device data model 22 and device business logic 24.

Moreover, the FDI host 12 may create and export, or import one or more configuration files 50. These configuration files 50 may be used to enable data to be imported into and exported from the FDI host 12, typically in a proprietary format. The configuration files 50 may thus enable the FDI host 12 to import or export configuration files for the field device 14 from and to other systems. Likewise, the FDI host 12 may import, use and provide to a user the attachments 42 and the protocol specific files 44.

As illustrated in FIG. 1, the FDI host 12 uses an FDI client/server architecture to implement or control field device operations and user interface operations. In particular, the device engine 21 within the FDI host 12 implements the on-line and off-line device data model 22 and the on-line and off-line device business logic 24 during both on-line and off-line operations, and operates as an FDI server to provide requested or published device information to the UI engine 16, which is implemented as an FDI client. The UI engine 16 uses the user interface logic 18 and the UI business logic 20 to perform user interface operations at the FDI host 12 including implementing user interface operations, graphics, screens, data display, read and write requests, configuration changes, etc. with respect to a user and to the device engine 21. As illustrated in FIG. 1, the user interface logic 18 may be implemented using a web graphics technology (e.g., HTML5) or as a device description language (e.g., EDDL). Likewise, the UI business logic 20 may be implemented as a web programming language or open protocol language, such as JavaScript, or as a device description language (e.g., EDDL). Likewise, the device data model 22 and the device business logic 24, for the device engine 21 are typically implemented or specified using a device description language (e.g., EDDL).

As also depicted in FIG. 1, the FDI communication server 28 operates to interface with the field device 14 (using the communication protocol supported by the field device 14, e.g., HART, Fieldbus, etc.) and maps the device data (specified within the field device communication protocol) from the field device 14 to an OPC UA protocol or data structure. The device engine 21 (and in particular, the business logic 24 of the device engine 21) subscribes to (using pub/sub messages) information from the FDI server using an OPC UA interface and then uses the mapped data from the field device 14 (and delivered from the FDI communication server 28) to update the device model 22 and to perform device simulation for the field device 14. The device engine operates as an OPC server and communicates with the UI engine 16 using an OPC UA communication protocol or data mapping model. Likewise, the UI engine 16, which operates as an OPC client, uses the OPC UA interface to communicate with the device engine 21, using publish/subscribe messaging, for example.

When used in an on-line implementation, the device engine 21 interfaces with the FDI communication server 28 via the OPC UA communication protocol interface and the FDI communication server 28 maps the OPC UA data to device data in the field communication protocol (e.g., Fieldbus, HART, Profibus, etc.). Moreover, the FDI communication server 28 maps field device data from the field device 14 to the OPC UA communication model for delivery to the device engine 21.

While the FDI host structure or architecture of FIG. 1 uses OPC UA to implement an FDI host client/server structure, this architecture still requires significant device model development, in the form of a device data model 22 and device business logic 24, which data model and logic typically need to be programmed in an EDDL or other device description language to assure operation. In particular, the device engine 21 within the FDI host 12, including the device data model 22 and the device business logic 24 are used for both on-line and off-line operation of the FDI host, making it important that the device engine 21 fully represents all of the operations of the field device 14. This programming task basically attempts to recreate or specify a device model already implemented within firmware in the field device 14 in a device programming language. Because the device engine 21 of the FDI host 12, as provided by the FDI device package 40, tries to mimic the operation of the actual field device 14 at all times, the creation and testing of this device engine requires significant programming effort and is not scalable. Moreover, this structure does not easily accommodate the use of an FDI system with field devices or other devices that support communications using open or accessible information models such as the OPC UA communication model.

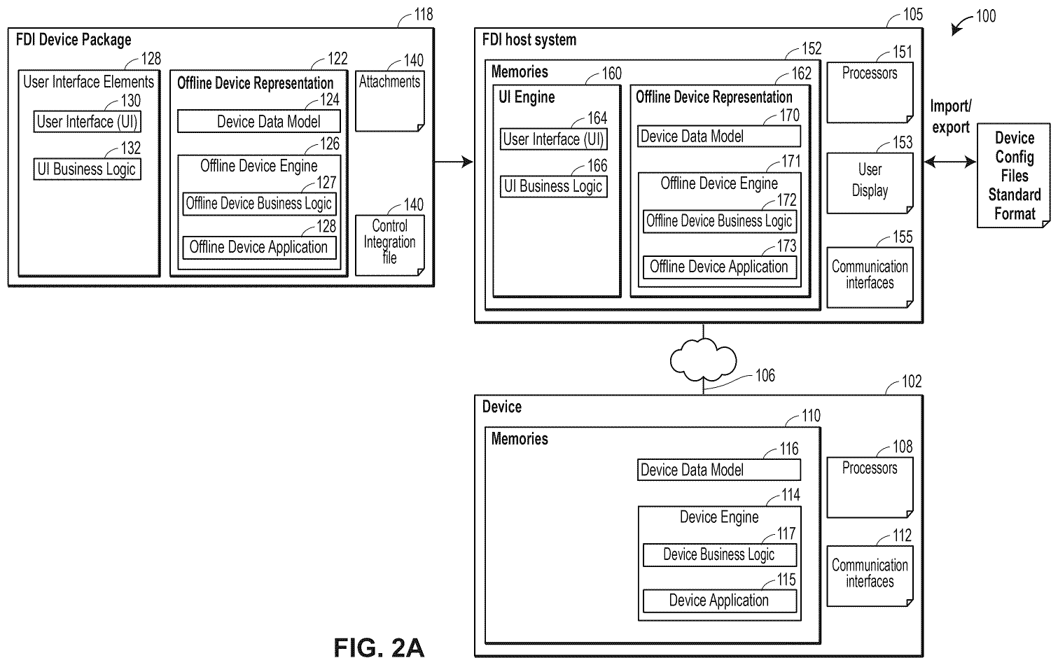

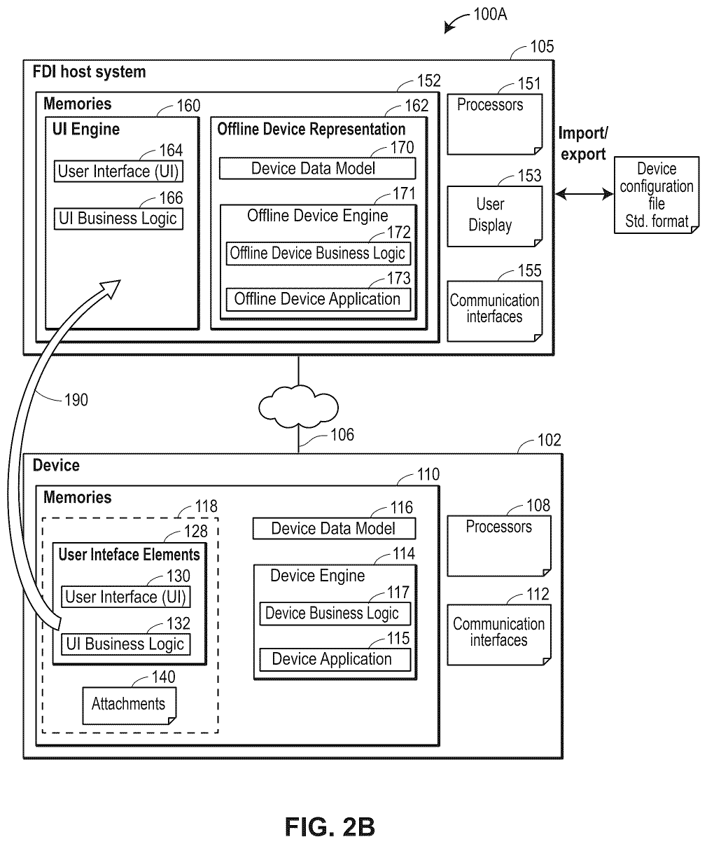

An FDI system, such as that illustrated in any of FIGS. 2-10 may be used to optimize or simplify FDI system configuration and support in situations in which the FDI system is used to support an OPC UA, an OPC UAFX device or other device (which may be field devices, switches, PLCs or any other devices that support such a protocol) that uses or supports a common communication mapping model and information model that maps device parameters for different types of devices into a common communication map using an extendable information model. The structure of the FDI systems of FIGS. 2-10 simplifies the creation or development of FDI packages for devices that support or include OPC UA or OPC UAFX functionality and optimized FDI host operation in both on-line and off-line situations. Moreover, these architectures reduce the amount of effort needed to create or program a device model or device engine both for on-line and off-line purposes, and makes the off-line device model creation scalable, enabling a device manufacturer to provide different levels of device simulation depending on the device.

In particular, the FDI systems illustrated in FIGS. 2-10 utilize the inherent capabilities of more advanced devices, such as the OPC UA and OPC UAFX devices, which include the capability to support communications using an open and extensible communication and information model. In these cases, the FDI host needs only minimal structure to support and communicate with a field device in an on-line situation and, in particular, can simply perform user interface functions, while relying on the field device itself to perform the actions associated with or that use a device model. In fact, in these cases, the FDI host may not need to receive an FDI package as the FDI host can obtain the needed programming to support the field device from the field device itself. Still further, in an off-line embodiment, the FDI host performs user interface functions in the same manner as in the on-line situation, by communicating with a field device representation that models the operation of the field device instead of with the field device itself. Here, the field device representation may receive an FDI package that includes instructions or programming for a device engine and may be executed in an off-line environment, such as on the FDI host or in a separate computer or server connected to the FDI host. In this manner, the FDI host communicates with the off-line field device representation in an off-line implementation in the same manner as the FDI host communicates with the actual field device in an on-line implementation, simplifying the FDI package development. Moreover, the device engine of the off-line device representation can be configured with a device engine that models the operation of the device using any desired complexity, from a simple device model implemented using a PA-DIM, for example, to a complex vender supplied device simulation. The device vendor can thus provide the appropriate level of complexity to the device model used in the off-line environment via an FDI device package and does not need to, in all situations, fully recreate the device model used in the actual device for the FDI host system, as is currently necessary. Still further, the device manufacturer can decide or specify the specific programming structure or language to use to implement one or both of the UI interface engine and the device engine (in an off-line implementation), providing the device manufacturer a great deal of flexibility in this regard.

FIG. 2A illustrates a generalized depiction of the architecture of an FDI system 100 that enables simpler and more scalable device support via an FDI host, especially when used to support OPC UA and OPC UAFX devices. In particular, the FDI system 100 of FIG. 2A reduces or eliminates the need for an FDI host to store and implement a complex device representation having a highly accurate device data model and set of device business logic when operating to provide on-line support to a device. Moreover, the FDI system of FIG. 2A enables an FDI host to use any desired type or complexity of device representation to model device behavior when operating in an off-line environment to provide off-line support for a device, which makes the off-line device representation highly scalable based on the particular needs of the FDI system.

As depicted in FIG. 2A, the FDI system 100 includes one or more field devices 102 communicatively connected to an FDI host 105 via one or more communication networks 106, which may be any wired or wireless or a combined wired and wireless communication networks. The field devices 102 shown in FIG. 1 include one or more processors 108, one or more non-transitory memories 110, and one or more communication interfaces 112 via which the field device 102 may communicatively connect to the FDI host 105 (and to other devices) via the one or more communication networks 106. Importantly, in this case, the communication interfaces 112 of at least some of the field devices 102 implement a communication architecture or protocol that relies or uses a common information model to perform communications, such as the OPC UA or OPC UAFX communication protocol, and that enables communication of information between devices manufactured by different manufacturers. Still further, as illustrated in FIG. 2A, the field device 102 includes a device engine 114 which includes or implements a device data model 116 and a set of device business logic 117, which are typically stored in and implemented in a device application 115 in firmware on the device 102. As will be described in more detail below, the device engine 114 implements, using the device application 115), device operation using the device data model 116, which defines the device parameters and interactions or relationships therebetween, and the device business logic 117 which implements or defines the logic of the device operation based on the device data model 116 (i.e., to keep the data model consistent, to enable changes to, reads and writes from, etc. the device data model 116). More particularly, the device data model 116 may contain data for both application and for communication configuration as well as dynamic device health and monitoring data of the device. Depending on the user role and access rights, the access to the device data model 116 may be restricted. Still further, the device business logic 117 is or includes a set of logic or programming that is responsible for maintaining the consistency of the device data model 116 (e.g., dependencies between parameters). The device business logic 117 controls data changes of or to the device data model 116 triggered both from the field device 102 itself (e.g., due to a change of process values, change of device health) as well as from external actors (e.g., due to a change of device configuration via an FDI host). The device business logic 117 also controls relations between parameters (e.g., the relations between the engineering unit of a parameter and its ranges).

The communication network(s) 106 may include any combination of wired and/or wireless communication links, busses, networks, etc. to which one or more other devices and/or computing systems in a plant (not shown in FIG. 1) or outside of a plant environment are communicatively connected and may be implemented using any desired network technology, including internet and cloud-based technology.

Still further, as illustrated in FIG. 2A, an FDI device package 118 (also referred to interchangeably herein as a “device package” or “FDI package”) is provided by, for example, a device manufacturer. In this case, the FDI package 118 is a separate file that includes an off-line device representation 122 for use in off-line device simulation or support of the field device 102. More particularly, the off-line device representation 122 includes a device data model 124 for off-line operation, and a device engine 126 having a set of device business logic 127 for off-line operation as well as a device application 128 which operates using the device data model 124 and the device business logic 126 to perform device simulation. Generally speaking, the device data model 124 is based on or is a copy of part of the device data model 116 stored in firmware of the field device 102 and may contain data for both application and for communication configuration as well as dynamic device health and monitoring data in an off-line implementation. Depending on the user role and access rights, the access to the device data model 124 may be restricted. Still further, the device business logic 127 is or includes a set of logic or programming that is responsible for maintaining the consistency of the device data model 124 (e.g., dependencies between parameters). The device business logic 127 which may also be based on or may be a subset of the device business logic 117 stored in firmware in the device 102, controls data changes of or to the off-line device data model 124 triggered both from the off-line representation of the field device 102 itself (e.g., due to a change of process values, change of device health) as well as from external actors (e.g., due to a change of device configuration via an FDI host). The device business logic 127 for off-line operation also controls relations between parameters (e.g., the relations between the engineering unit of a parameter and its ranges).

In some implementations, in addition to the device description files or the device engine 122, the FDI device package 118 may include other functional or executable files such as User Interface Plug-ins (UIPs) 128 or other mechanisms for powering and controlling graphical user interfaces, field device applications, and the like. Generally, the UIPs 128, also referred to herein as UI engines, may include a set of user interface (UI) instructions or programming 130 that defines the programming associated with the operation of a user interface for displaying and communicating device data with a field device 102 and for controlling device interactions, and a set of UI business logic 132 that defines the logic implemented during or by operation of the UI interface, such as parameter relationships, display features, etc. In particular, the UI business logic 132 implements and controls the dynamic aspects of the user interface. For example, the UI business logic 132 may control the visibility of UI elements dependent on the state of the device data and generally includes programming that controls the operation or logic of the UI interface defined by the UI instructions or framework 130.

In some implementations, the FDI device package 118 may include one or more other types of files 140, which are conventionally referred to as FDI device package “attachments” and integration files, both referred to as attachments. FDI device package attachments (e.g., integration files 140) may include, for example, protocol integration files (e.g., a PROFIBUS general station (GSD) file, a FOUNDATION FIELDBUS capability file (CFF), an OPC UAFX offline descriptor file, etc.), device user manuals, device wiring diagrams, device data sheets, and/or other types of attachments.

Typically, the device representation 122 (and the UIPs 128 and attachments 140, if any) are implemented in a format, syntax, or convention that is generally platform—(e.g., operating system-), protocol-, and Human Machine Interface-(HMI-) neutral. In an embodiment, the off-line device representation 122 may be implemented using EDDL (Electronic Device Description Language). Alternatively, the off-line device representation 122 may be implemented by a standardized format or model, such as unified Process Automation Device Information Model (PA-DIM) or another type of Open Platform Communications United Architecture (OPC-UA)-compatible information format or model. In some embodiments, the FDI device package 118 may include multiple off-line device representations 122 of different formats, syntaxes, or conventions, such as an EDDL device description, a PA-DIM model, an OPC-UA model, and/or other suitable models or descriptions which are generally platform—(e.g., operating system-), protocol-, and Human Machine Interface-(HMI-) neutral.

The FDI host system 105, as depicted in FIG. 2A, includes one or more processors 151, one or more non-transitory memories 152, one or more user display devices 153 (e.g., display screens such as desktop displays, laptop displays, phone displays, etc.) and one or more communication interfaces 155 via which the FDI host 105 may communicatively connect to various field devices (including the field devices 102) and to other devices via the one or more communication networks 106. Again, importantly in this case, the communication interfaces 155 of the FDI host 105 may implement a communication architecture or protocol that relies or uses a common and extensible information model to perform communications, such as the OPC UA or the UPC UA FX communication protocol, and that enables communication of information between devices manufactured by different manufacturers. In particular, the communication protocol used by the communication interfaces 155 to communicate with the device 102 may use a communication paradigm that uses an open and extensible information model that models or supports device data from multiple different device communication protocols or device manufacturers and that thus enables device data from different types of devices and from different manufacturers of devices to be modeled and used (understood or supported) in the communication paradigm. Examples of such communication paradigms include the OPC UA and the OPC UA FX communication protocols.

As depicted in FIG. 2A, the FDI host 105 includes a UI engine 160 and, in some cases, an off-line device representation 162, wherein the UI engine 160 includes a set of UI instructions 164 and a set of UI business logic 166 and wherein the off-line device representation 162, if present, includes an offline device data model 170 and an offline device engine 171 having a set of offline device logic 172 and an offline device application 173 that may be used for off-line operation of the FDI host 105 based on the device data model 170. Generally speaking, the off-line device representation 162 is a copy of the device representation 122 of the FDI package 118 and is provided via importation of a file (the FDI package 118) directly to the FDI host 105, and so the device data model 170, the device engine 171, the device business logic 172 and the device application 173 are copies of or are derived from the device data model 124, the device engine 126, the device business logic 127 and the device application 128, respectively, of the corresponding FDI package 118. Moreover, while FIG. 2A illustrates the off-line device representation 162 as being within the FDI host 105, the off-line device representation 162 could be located in a separate computing device within an engineering environment, such as another computer device or server, which is communicatively coupled to the FDI host 105.

During operation of the FDI host 105, the UI engine 160 implements UI graphics and associated user interface display and input operations within the FDI host 105 for both on-line and off-line implementations via one or more of the user displays 153 (which may include a graphics display device as well as user input devices, such as a keyboard, a mouse, etc.) The UI engine 160 communicates with a corresponding field device 102 in an on-line implementation and communicates with a corresponding off-line representation of the corresponding field device 102 in an off-line implementation. As will be described in more detail, the UI instructions 164 and the UI business logic 166 implemented in the UI engine 160 of the FDI host 105 are copies of or are derived from the UI instructions 130 and the UI business logic 132, respectively, of the UI engine 128 of the corresponding FDI package 118 of the field device 102. Here, as will be understood, the UI business logic 166 controls the operation or logic of the UI interface while the UI instructions 164 implement the UI display, inputs, outputs, etc. of the UI interface.

The off-line device data model 170 and device logic 172 of the off-line device engine 171 are based on and, in some instances, may replicate the device data model 116 and the device business logic 117 of the field device 102 for which the FDI host 105 is performing off-line activities. In other cases, the device data model 170 and the device logic 172 may be a simplified version or representation of the device data model 116 and device business logic 117 of the device engine 114 of the field device 102. For example, the off-line device representation 162 within the FDI host 105 may be implemented using, for example, a semantic model, a standardized PA-DIM model, a vendor specific data model (implemented in EDDL or DSL for example), or a vendor specific device simulation. Thus, in some cases, the device data model 170 and the device business logic 172 for off-line operation may generally be based on and/or may contain a subset of the device data model 116 and device business logic 117 of the field device 102 and, in general, the off-line device representation 162 may only include the data necessary for configuration and parameterization tasks to be performed by the FDI host 105 in an off-line implementation. Thus, dynamic data for device monitoring, such as that used for device health or process values, need not be contained in the device data model 170 for off-line operation. The stored off-line configuration is typically exchangeable between FDI hosts 105 and other devices via a standardized exchange format and the loading of the off-line configuration into the field device 102 or into the FDI host 105 can either be performed parameter by parameter or in a bulk download.

Importantly, the FDI system 100 of FIG. 2A is configured in a manner that enables the FDI host 105 to support OPC UA and OPC UA FX compatible field devices 102 both in an on-line environment and in an off-line environment. In an on-line environment, the FDI host 105 is communicatively connected to the device 102 operating on-line in a plant or factory, on a test bench, etc., while in an off-line environment, the FDI host 105 is not communicatively connected to the field device 102 but operates to support the field device 102 by, for example, communicating with an off-line device representation of the field device 102 to simulate the operation of interactions of the FDI host 105 with the field device 102 and/or to make configuration changes to the field device 102 via configuration files which may be created and later downloaded to the field device 102 when the FDI host 105 connects to the field device 102.

Generally speaking, as will be understood from the detailed discussion below, the FDI host 105 of the FDI system 100 of FIG. 2A uses OPC UA or OPC UA FX communications, including using an OPC UA client/server based architecture, to perform communications with a field device 102 or a representation of a field device 102 to provide or implement on-line and off-line support of the field device 102 in a manner that eliminates or minimizes the FDI package development needed for the field device 102, that enables various different web based or device language based technology to be used in the FDI packages, that reduces or eliminates the need to provide separate FDI packages to the FDI host 105 in an on-line environment, and that enables a field device vendor to provide different levels or complexity of device simulation using different device representation technologies in an off-line environment, thus making the off-line device simulation scalable based on the type of field device being supported.

In the system of FIG. 2A, the FDI package 118 is provided as a separate file from, for the example, the device 102 manufacturer, and is imported to the FDI host 105 using any conventional importation techniques. Alternatively the FDI package 118 can be provided as a separate file by the device manufacturer or a package manufacturer through a repository of some sort, such as a repository managed by an FDI registration authority, for example. Alternatively, the FDI package 118 or components thereof could be delivered to the FDI host 105 in other manners. For example, FIG. 2B illustrates an alternative FDI system 100A in which some or all of the components of the FDI package 118 are stored in the device 102 and are delivered to FDI host 105 by the device 102 when the FDI host 105 first connects to the device 102. In this case, a manufacturer of the field device 102 would typically store or load the FDI package 118 or some components thereof into the device memory 110 prior to the device 102 being installed in, for example, a field environment of a plant or factory.

In the example illustrated in FIG. 2B, the FDI package 118 stored in the memory 110 of the device 102 includes only the UI engine 128 with the UI interface 164 and the UI business logic 166 as well as the attachments 140. As indicated by the arrow 190, these components are provided from the device 102 to the FDI host 105 when, for example, the FDI host 105 first communicatively connects to the device 102. The UI engine 128 stored in the device 102 is then provided to and used as the UI engine 160 in the FDI host 105 as described above with respect to FIG. 2A. While the example of FIG. 2B does not specifically illustrate an off-line device representation (such as the off-line device representation 122 of FIG. 2A) as being stored as part of the FDI package 118 in the memory 110 of the device 102, an off-line device representation, if needed, could be stored in the FDI package 118 of the device 102 and could be communicatively provided (as indicated by the arrow 190) for use as the off-line device representation 170 of the FDI host 105 after the FDI host disconnects from the device 102 and needs to operate in an off-line manner with respect to the device 102. Alternatively, in some cases, such as when the FDI host 105 will only perform on-line activities with respect to the device 102, an off-line device representation is not needed. In other cases, an off-line device representation could be provided to the FDI host 105 via a separate import or download from another source.

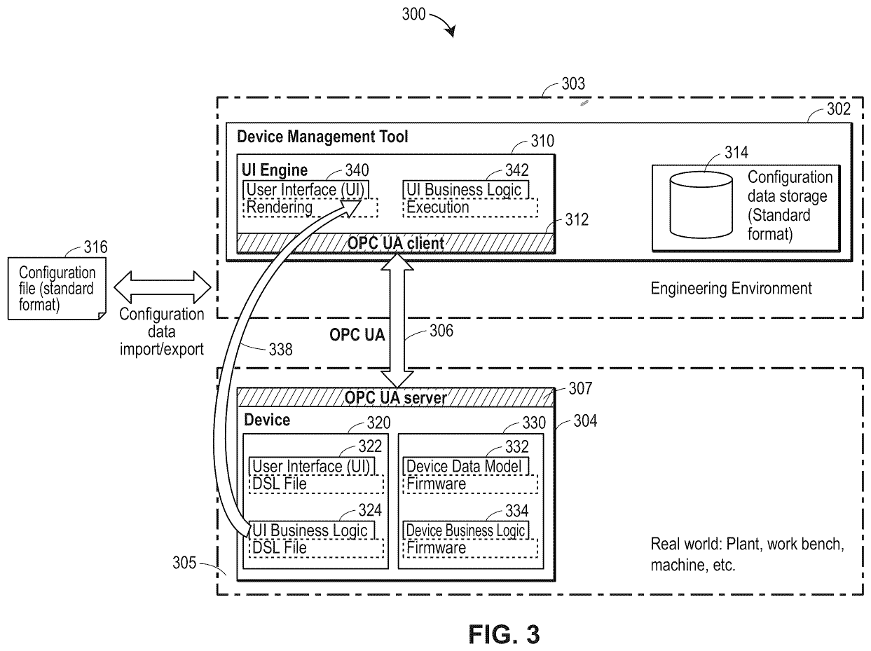

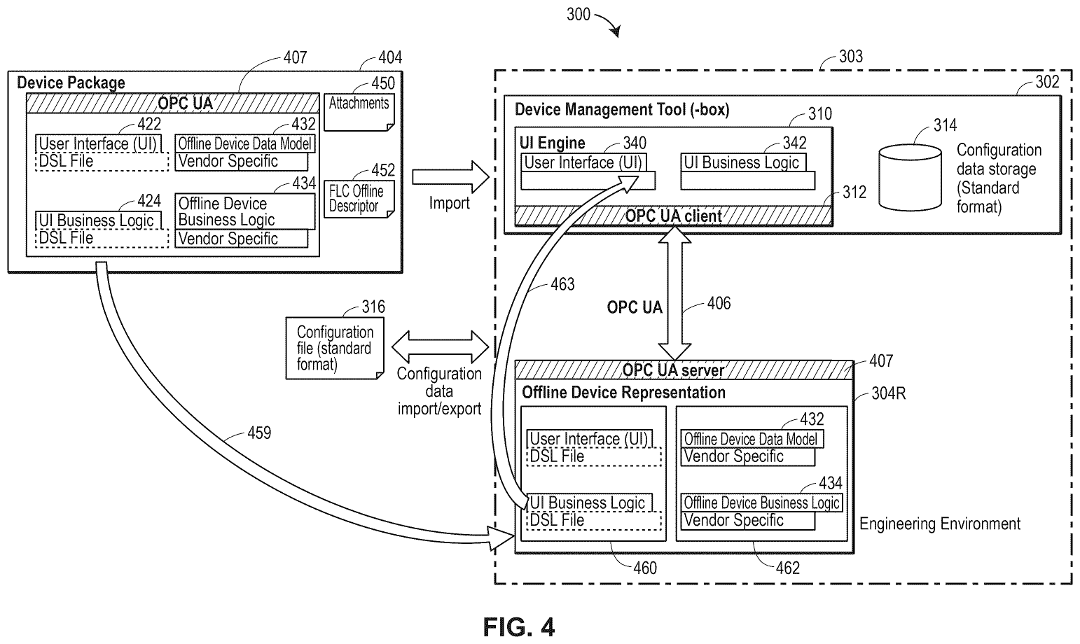

As will be understood from the following discussion, the new FDI systems 100 and 100A as generally illustrated in FIGS. 2A and 2B could use various different technologies for implementing the on-line and off-line UI functions, the off-line device modeling or simulation functions and the on-line and off-line communication functions needed to perform both on-line and off-line activities with respect to one or more devices 102 that are being supported by an FDI host 105. FIGS. 3 and 4, depict a first and basic FDI system or architecture that incorporates or uses an OPC UA client/server communication structure disposed between a field device and an FDI host. FIG. 3 depicts an on-line use in which the UI engine and its associated files or components or stored in the device and provided to the FDI host by the device, but it will be understood that the UI engine and associated files could be provide from a separate file or FDI device package as illustrated in FIG. 2A. Moreover, FIG. 4 depicts an off-line use of this first embodiment in which the UI engine and device representation are provided to the FDI host via a separate FDI device package. In either of these cases, the UI engine may be implemented using a device description language, such as the Domain Specific Language (DSL), which is an evolutionary development to EDDL, but may also be implemented using other open technology, such as a web programming or web server language like HTML and JavaScript. Importantly, the FDI host, in this embodiment, only needs to include or implement a UI engine that communicates with the field device (in an on-line embodiment) or that communicates with the field device representation (in an off-line embodiment) via an OPC UA client/server architecture to perform UI rendering. In the on-line implementation, the field device includes and implements both a UI file server (which may store UI files programmed using an EDDL, such as DSL) and the device engine (typically implemented in firmware of the field device). In an off-lime implementation of FIG. 4, the device simulation may store and implement both a UI file server (which may store UI files programmed using an EDDL, such as DSL) and the device representation or simulation engine programmed at any desired level of complexity to simulate the operation of the actual device.

More particularly, FIG. 3 illustrates an FDI system 300 configured using this first architecture. In this case, an FDI host or management tool 302 is disposed in an engineering environment 303 and is coupled to a device 304 (referred to herein as a field device although it could be other types of devices) in a real-world environment 305. Here, the real-world environment 305 may be within a plant or on a factory floor, for example, a test bench, etc. As illustrated in FIG. 3, the FDI host 302 is communicatively coupled to the field device 304 via a communication network 306 (which may implement the communication network 106 of FIG. 2 or 2A). In this example, the field device 304 is compliant with or supports an OPC UA communication interface 307 (or other communication interface that uses an open and extensible information model to model device parameters and information) and operates as an OPC UA server. The FDI host 302 includes a UI engine 310 coupled to an OPC UA communication interface 312 (or other communication interface that uses an open and extensible information model to model device parameters and information). Here, the UI engine 310 is an OPC UA client and communicates with the field device 304, and the UI engine 310 operates as an OPC UA server, to receive data and other information from the field device 304, to send configuration and other parameters or instructions to the field device 304, etc., using an OPC UA communication paradigm such as publish/subscribe communications. The FDI host 302 also includes a memory or data storage 314 which may store configuration data, etc. in any standard format. The FDI host 302 may also import and export one or more configuration files 316 to store configuration and other information in the data storage 314 or to export configuration data to the data storage 314 for access by other users as configuration files 316 provided in a standard or open format. Of course, the UI engine 310 may interface with the data storage 314 to obtain data therefrom and to store data thereto.

As also illustrated in FIG. 3, the field device 304 includes a UI file server 320 having a set of UI programing files 322 and a set of UI business logic files 324, each of which may be programmed as or provided to the field device 304 as a DSL file or as other types of files such as files programmed using well-known web technologies, such as HTTP, HTML, JavaScript, etc. The UI programming file 322 and the UI business logic files 324 generally make up a UI engine. Additionally, the field device 304 includes a device engine 330 which includes a device data model 332 and device business logic 334 stored in and implemented in, for example, firmware of the field device 304.

When the FDI host 302 connects to the field device 304, the FDI host 302 may first interact with or communicate with the field device 304 (via the OPC UA interfaces 312 and 307) to obtain the user interface programming files 322 and the UI business logic files 324 for use in the UI engine 310 to be implemented at the FDI host 302. This is illustrated by the arrow 338 in FIG. 3. Of course, as noted above, the files 322 and 324 could be provided to the FDI host 302 as separate files or from another source. In any event, the UI engine 310 then operates a UI rendering engine 340 and executes the UI business logic 342 (using the files 322, 324 obtained from the field device 304) to interact with a user and with the field device 304 to perform configuration and commissioning activities, for example. In this case, the field device 304 retains and implements the device data model 332 and the device business logic 334, and the FDI host 302 may interact with the device engine 330 of the field device 304 as needed to implement configuration, read and write operations, etc. as mandated by the user interactions with the UI engine 310 of the FDI host 302. Of course, all interactions between the UI engine 310 and the field device 304 take place using an OPC UA information model, OPC UA communications, and an OPC UA client/server architecture provided between the UI engine 310 and the field device 304. This architecture enables the FDI host 302 to operate in an on-line environment without needing to use or have a separate on-line device model, but instead interacts with the actual device engine 330 in the field device 304 to perform configuration of and communications with the field device 304. Likewise, if desired, the UI files 322 and 324 used by the FDI host 302 can be provided by the device manufacturer in the field device 304 itself, meaning that there is no need for an FDI package to be provided to the FDI host 302 prior to the FDI host 302 being connected to the field device 304.

FIG. 4 illustrates the FDI host 302 of FIG. 3 used in an off-line environment. Here, the FDI host 302 includes the same elements as illustrated in FIG. 3, including the configuration database 314, the UI engine 310 having the UI rendering engine 340 and the UI business logic 342 coupled to the OPC UA communication interface 312. However, in this case, the UI engine 310 is connected to an off-line device representation 304R of the field device 304 of FIG. 3. The device representation 304R may be stored in and implemented in the FDI host 302 but may also be stored in and executed in any other desired computer or server in, for example, the engineering environment 303 (as is illustrated in FIG. 4).

Additionally, in this case, an FDI package 404 which may be provided by the device manufacturer of the field device 304 of FIG. 3, includes an off-line device representation having an OPC UA communication interface (or information model) 406, a UI rendering file or programming instructions 422 and UI business logic 424 as well as a device representation or device engine including a device data model 432 and a set of device business logic 434. The device data model 432 and the device business logic 434 can be of any type or complexity as specified by the device manufacturer and thus can be simple in nature (such as including a standardized PA-DIM), can be medium complexity, such as a vendor specific data model, or can be complex in nature such as a vendor specific device simulation. In some cases, the device data model 432 and device business logic 434 can be based on, can be a subset of or can include all of the device firmware of the field device 304 of FIG. 3. The FDI device package 404 may also include attachments 450 and an FLC offline descriptor file 452 which may be used by the FDI host 302 during operation.

Prior to operation of the FDI host 302 in an off-line configuration (e.g., in a device or plant simulation mode, for example), as illustrated by the arrow 459, the FDI package 404 is provided to and downloaded into the engineering environment 303 to create the device representation 304R as including the OPC UA interface 407, a UI file server 460 including the UI rendering files 422 and the UI business logic 424, and an off-line device engine 462 including the device data model 432 and the device business logic 434. Next, the UI engine 310 then connects to the field device representation 304R via the OPC UA client/server interface 312/407 over a network or communication link 406 within the engineering environment 303 and obtains the UI rendering and business logic files 422 and 424 in a manner similar to the manner in which the FDI host 302 of FIG. 3 connects to and obtains these same files from the actual field device 302 in an on-line environment. This operation is indicated by the arrow 463 of FIG. 4. Thereafter, the UI engine 310 uses these files or programs to perform UI rending and UI control as well as communications with respect to the field device representation 304R and so, essentially, operates or communicates with the field device representation 304R as if it were the actual field device 304. Here, the field device representation 304R implements the device data model 432 and the device business logic 434 to simulate the operation of the actual field device 304 and thus enables the FDI host 302 to perform simulated device configuration of the field device 304, reads and writes to the field device 304, and other operations to, for example, create or change one or more device configuration files for the field device 304 in an off-line environment. These configuration files can then be downloaded to the field device 304 or other devices as one or more of the configuration files 316. While the example of FIG. 4 illustrates that the device representation 304R is first provided with the UI engine files 422, 424 from the device package 404 and that the device representation 304R then provides these files to the FDI host 302, the FDI host 302 could obtain these UI engine files directly from the device package 404 without these files going through the device representation 304R.

As will be understood, the architecture of FIGS. 3 and 4 enable the FDI host 302 to generally only include or use the UI rendering engine which operates essentially the same in both an on-line environment and in an off-line environment and which uses a device engine stored in firmware of the actual field device (in an on-line implementation) or a device model stored in a separate device representation in an off-line implementation to interact with or simulate interaction with a field device. This feature enables a device manufacturer to use the actual device engine already stored in the field device in an on-line implementation, and to provide device data models and device business logic files for use in simulating field device operation in an off-line implementation at any desired level or complexity and using any desired technology, which in turn reduces the programming and testing effort needed to generate an FDI package for a field device. This architecture further reduces and/or simplifies the programming the device manufacturer needs to perform for both UI actions and device modeling, as it enables the device manufacturer to use the OPC UA information model and OPC UA communication structure within the field device to perform all communications with the FDI host. Moreover, in an on-line situation, the manufacturer may not need to create a separate FDI package, as the device engine is executed in the field device as normal, and the device manufacturer can provide the UI engine to the FDI host via the field device itself.

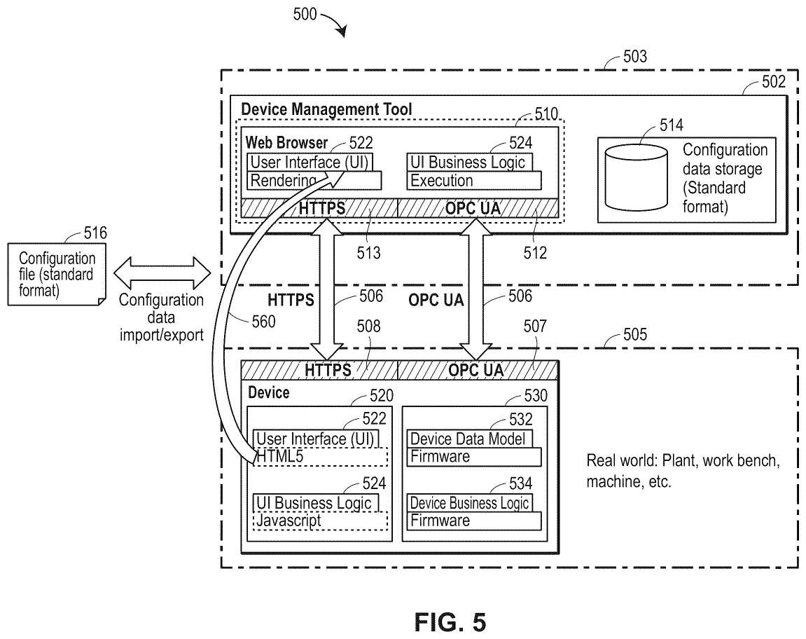

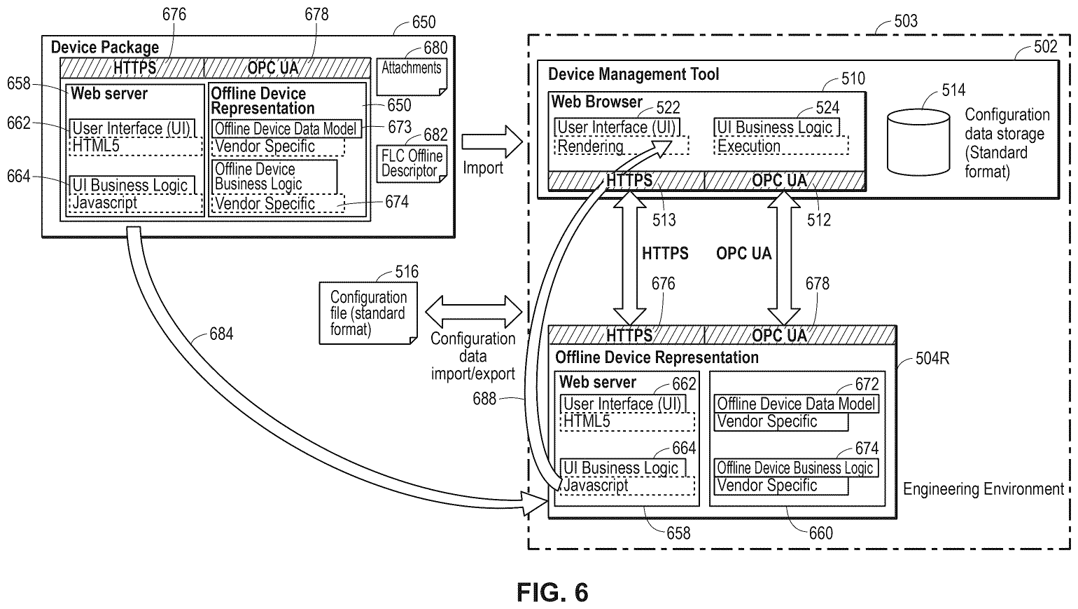

FIGS. 5 and 6, depict a second FDI system or architecture 500 that incorporates or uses both an HTTP or other web server, and an OPC UA client/server communication structure disposed between a field device or a field device representation and an FDI host. Again the term “field device” is used herein to include typical field devices such as measurement and actuation devices as well as to include other devices which are not typically considered to be “field devices” as that term is used in the process control and automation industry, including switches, PLCs, gateways, communication devices, etc. Here, again UI engine files and the device engine are stored in the field device (in an on-line embodiment) or in a device representation (in an off-line embodiment). In this case, the UI engine may be implemented using a traditional web or user interface paradigm, such as HTML, and may use a simple or well-known programming language, such a JavaScript, to implement UI logic. Likewise, the FDI host may perform UI related and file server communications using a traditional web communication protocol, such as HTTP while implementing device communications related to the device engine using the OPC UA protocol. Again, the FDI host, in this embodiment, only needs to include or implement a UI engine that communicates with the field device (in an on-line embodiment) or that communicates with the field device representation (in an off-line embodiment) via either a web based protocol or an OPC UA client/server architecture to perform UI rendering. The field device or the field device representation includes the device engine (typically in firmware of the field device or provided to a device representation by an FDI package) and may store and provide UI rendering files directly to the FDI host for use in communicating with the field device or the field device representation.

More particularly, FIG. 5 illustrates an FDI system 500 configured using this second, dual server, architecture in an on-line environment. In this case, an FDI host or management tool 502 is disposed in an engineering environment 503 and is connected to a field device 504 (operating on-line in a real-world environment 505, such as a plant or factory environment or a test bench) via a communication network 565. The field device 504 is compliant with or supports an OPC UA communication interface 507 (or other communication interface that uses an open and extensible information model to model device parameters and information). However, the field device 504 additionally supports or includes a web server interface 508 that communicates using a web protocol, such as HTTPS. As in previous examples, the FDI host 502 includes a UI engine 510, which is coupled to an OPC UA communication interface 512 (or other communication interface that uses an information model to model device parameters and information). However, the UI engine 510 is also coupled to or includes a web server communication interface 513 using a web communication paradigm, such as HTTP or HTTPS and the UI engine 510 is implemented as a web browser. Thus, in this case, the UI engine 510 is both an OPC UA client and a web server client and may communicate using one of these communication links for different purposes. In particular, the UI engine 510 communicates with the field device 504 using an OPC UA server architecture and the OPC UA interface 512/507, to receive device data and other device information from the field device 504, to send configuration data, read requests, write requests and other parameters or instructions, etc., to the field device 504, using an OPC UA communication paradigm. However, the UI engine 510 may communicate with the field device 504 using the web interface 513/508 to receive UI related information and UI files from the field device 504. As illustrated in FIG. 5, the FDI host 502 also includes a memory or data storage 514 which may store configuration data, etc. in any standard format. The FDI host 502 may also import and export one or more configuration files 516 to store configuration and other information in the data storage 514 or to export configuration data from the data storage 514. Of course, the UI engine 510 may interface with the data storage 514 to obtain data therefrom and to store data thereto.

Again, in this case, the field device 507 includes a file server 520 (implemented using web based technologies) coupled to the HTTPS server interface 508 and a device engine 530 coupled to the OPC UA interface 507. The web server 520 stores a set of UI programing files 522 and a set of UI business logic 524, each of which may be programmed in and implemented as a web technology, such as using HTML for rendering and JavaScript for the UI business logic. Additionally, the device engine 530 includes a device data model 532 and device business logic 534 stored in and implemented in, for example, firmware of the field device 504.

As illustrated by the arrow 560, when the FDI host 502 connects to the field device 504, the FDI host 502 may first interact with or communicate with the field device 504 (via the web interface 513/508) to obtain the user interface programming files 522 and the UI business logic files 524 for use in the UI engine 510 to be implemented at the FDI host 502. (Alternatively, the FDI host 502 may obtain the UI engine files from a separate FDI package, not shown in FIG. 5). The UI engine 510 then operates as UI rendering engine and executes the UI business logic 524 (using the files obtained from the field device 504) to interact with a user and with the field device 504. However, during operation, the UI enter 510 interfaces with the field device 504 via the OPC UA interface 512/507 to obtain device data from and to send device or configuration data, read/write requests, etc. to the field device 504. In this case, the field device 504 retains and implements the device data model 532 and the device business logic 534, and the FDI host 502 may interact with the device engine 530 of the field device 504 as needed to implement configuration, read and write operations, etc. as mandated by the user interactions with the UI engine 510 of the FDI host 502. Of course, all interactions between the UI engine 510 and the field device 504 regarding device data take place using an OPC UA information model and a OPC UA client/server architecture provided between the UI engine 510 and the field device 504 by the communication interface 512/507. This architecture enables the FDI host to operate in an on-line environment without needing to use or have an on-line device model, but instead interacts with the actual device engine in the field device 504 to perform configuration of and communications with the field device 504. Likewise, the UI engine files 522 and 524 used by the FDI host 502 can be provided by the device manufacturer in the field device 504 itself or via a separate FDI device package file, and can program these components using well known and easy to implement web programming and communication paradigms, such as HTML, JavaScript and HTTPS.

FIG. 6 illustrates the FDI host 502 of FIG. 5 used in an off-line environment. Here, the FDI host 502 is again disposed in an engineering environment 503 and includes the same elements as illustrated in FIG. 5, including the configuration database 514, the UI engine 510 implemented as a web browser and having the UI rendering engine 522 and the UI business logic 524 coupled to the OPC UA communication interface 512 and the web interface 513. However, in this case, the UI engine 510 is connected to an off-line device representation 504R of the field device 504 of FIG. 5. The device representation 504R may be stored in and implemented in the FDI host 502 but may also be stored in and executed in any other desired computer or server in, for example, the engineering environment 503 (as is illustrated in FIG. 6).

Additionally, in this case, an FDI package 650 which may be provided by the device manufacturer of the field device 504 of FIG. 5, includes a file server (implemented as a web server) 658 and an off-line device representation or model 660. The file server 658 includes a UI rendering file or programming instructions 662 and UI business logic 664, and the off-line device representation 660 includes a device data model 672 and a set of device business logic 674. The device data model 672 and the device business logic 674 can be of any type or complexity as specified by the device manufacturer and thus can be simple in nature (such as including a standardized PA-DIM), can be medium complexity, such as a vendor specific data model, or can be complex in nature such as a vendor specific device simulation. In some cases, the device data model 672 and device business logic 674 can be based on, can be a subset of or can include all of the device firmware of the field device 504 of FIG. 5. Still further, the FDI device package 650 includes a web interface, such as an HTTPS interface 676 and an OPC UA interface 678. The FDI device package 650 may also include attachments 680 and an FLC offline descriptor file 682 which may be used by the FDI host 502 during operation.

Prior to operation of the FDI host 502 in an off-line configuration (e.g., in a device or plant simulation mode, for example), the FDI package 650 is provided to and downloaded into the engineering environment 503 to create the device representation 504R as including the interfaces 676 678, the file server 658 including the UI rendering files 662 and the UI business logic 664, and as including the off-line device representation 660 including the device data model 672 and the device business logic 674. This action is illustrated by the arrow 684. Next, the UI engine 510 of the FDI host 502 connects to the field device representation 504R via the web interface 513/676 and obtains the UI rendering and business logic files 662 and 664 in a manner similar to or the same as the FDI host 502 of FIG. 5 connects to and obtains these same files from the actual field device 502 in an on-line environment via the file server 658. This action is indicated by the arrow 688 Thereafter, the UI engine 510 uses these files or programs to perform UI rending and UI control and performs communications with respect to the field device representation 504R using the OPC UA interface 512/678 and so, essentially, operates or communicates with the field device representation 504R as if it were the actual field device 504. Here, the field device representation 504R implements the device data model 672 and the device business logic 674 to simulate the operation of the actual field device 504 and thus enables the FDI host 502 to perform simulated device configuration of the field device 504, simulated reads and writes to the field device 504, and other operations to, for example, create or change one or more device configuration files for the field device 504 in an off-line environment. These configuration files can then be downloaded to the field device 504 or other devices as one or more of the configuration files 516. While the example of FIG. 6 illustrates that the device representation 504R is first provided with the UI engine files 662, 664 from the device package 650 and that the device representation 504R then provides these files to the FDI host 502, the FDI host 502 could obtain these UI engine files directly from the device package 650 without these files going through the device representation or device model 504R.

As will be understood, the architecture of FIGS. 5 and 6 enable the FDI host 502 to operate essentially the same in both an on-line and an off-line environment, and enables a device manufacturer to provide device data models and device business logic files for use in simulating field device operation at any desired level or complexity and using any desired technology (as the device data model and business logic are executed in a field device or in a field device representation). Still further, this architecture reduces and/or simplifies the programming the device manufacturer needs to perform to create an FDI device package as it enables the device manufacturer to use the OPC UA information model to perform all communications with the FDI host when performing device data manipulation and simulation, but also provides the FDI host with an easy to use and understand UI interface which can be communicated to the FDI host with known web technologies. Likewise, in an on-line situation, there is no or only a limited need for the field device manufacturer to create a separate FDI package, as the device engine is executed in the field device as normal, and the device manufacturer can provide the UI engine to the FDI host via the field device itself. In any event, the device manufacturer does not need to provide a device model or device engine for on-line operation of the FDI host. Moreover, in this instance, the file transfer communications can be performed using a well-known web technology, such as that provided by an HTTPS web server, while device data communications can be performed using the OPC UA interface. This enables the use of web based technologies to be incorporated into the file server and use of well-known and more easily programmed UI interfaces using, for example, HTML and JavaScript (or another well-known programming language).

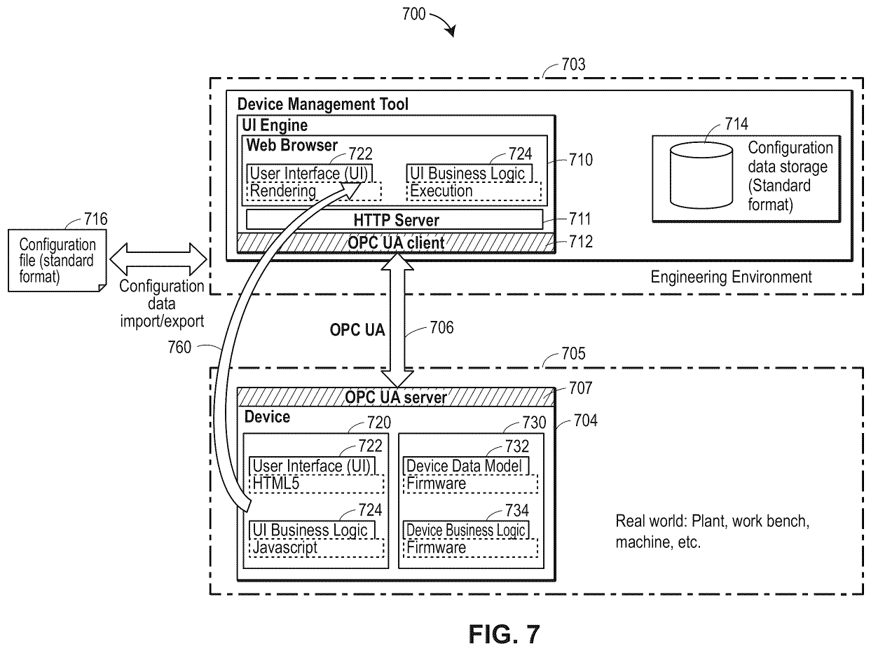

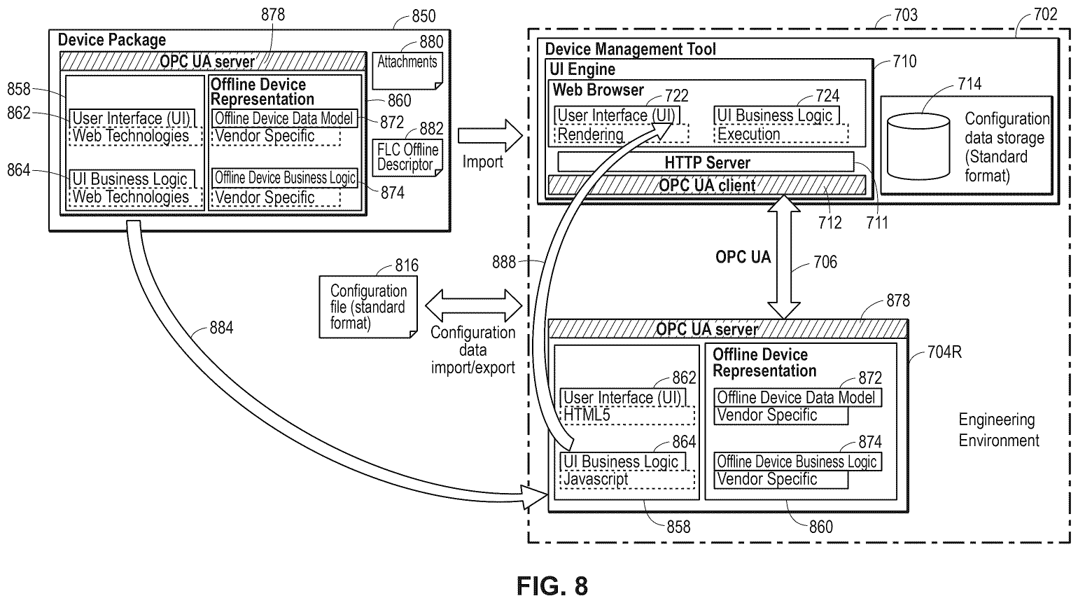

FIGS. 7 and 8, depict a third FDI system architecture 700 that also incorporates or uses both an HTTP or other web server, and an OPC UA client/server communication structure disposed in series between a field device and an FDI host. Here, again UI engine files and the device engine are stored in the field device (in an on-line embodiment) or in a device representation (in an off-line embodiment) but, as in the other examples, could be provided directly from an FDI device package. In this case, the UI engine may be implemented using a traditional web or user interface paradigm, such as HTML, and may use a simple or well-known programming language, such a JavaScript, to implement UI logic. Likewise, the FDI host may perform UI related and file server communications using a traditional web communication protocol, such as HTTP while implementing device communications related to the device engine using the OPC UA protocol. Again, the FDI host, in this embodiment, only needs to include or implement a UI rendering engine that communicates with the field device (in an on-line embodiment) or that communicates with the field device representation (in an off-line embodiment) via either a web based protocol or an OPC UA client/server architecture to perform UI rendering. The field device or the field device representation includes the device engine (typically in firmware of the field device or provided to a device representation by an FDI package) and may store and provide UI rendering files directly to the FDI host for use in communicating with the field device or the field device representation.

More particularly, FIG. 7 illustrates an FDI system 700 configured using this third, series configured server architecture in an on-line environment. In this case, an FDI host or management tool 702 is disposed in an engineering environment 703 and is connected to a field device 704 (operating on-line in a real-world environment 705, such as in a plant or factory) via a communication network 706 which is, specifically, an OPC UA communication network. Here, the field device 704 is compliant with or supports an OPC UA communication interface 707 (or other communication interface that uses an open and extensible information model to model device parameters and information). However, in this case, the FDI host 702 includes a UI engine 710 which is implemented in a web browser which is coupled to a web server 711, such as an HTTPS server. The server 711 is, in turn coupled to an OPC UA communication interface 712 (or other communication interface that uses an information model to model device parameters and information). Thus, in this case, the UI engine 710 implements web based technologies and communicates with the field device 704 via the web server 711 which generates and decodes web messages (e.g., messages in an HTTPS protocol). However, the HTTP server 711 is coupled to and performs communications within the OPC UA interface 712 which converts the messages into an OPC UA protocol (such as by tunneling HTTPS messages in some cases) and sends the messages through the OPC UA interface 712/707. The UI engine 710 can thus receive UI files from the field device 704 (sent as, for example, web messages tunneled in an OPC UA protocol message) and can send and receive device data and other device information from the field device 704 in the OPC UA protocol, to thereby send configuration data, read requests, write requests and other parameters or instructions, etc., to the field device 704, using an OPC UA communication paradigm. As illustrated in FIG. 7, the FDI host 702 also includes a memory or data storage 714 which may store configuration data, etc. in any standard format. The FDI host 702 may also import and export one or more configuration files 716 to store configuration and other information in the data storage 714 or to export configuration data from the data storage 714. Of course, the UI engine 710 may interface with the data storage 714 to obtain data therefrom and to store data thereto.

As illustrated in FIG. 7, the UI engine 710 of the FDI host 702 includes a file server 720 that stores a set of UI programing 722 and a set of UI business logic 724, each of which may be programmed in and implemented as a web technology, such as using HTML for rendering and JavaScript for the UI business logic. The UI programming 722 and the UI business logic 724 may be provided from the field device 704 to the FDI host 702 via the OPC UA interface 712/707 and the HTTP server 711. Additionally, the field device 704 includes a device engine 730 which includes a device data model 732 and device business logic 734 stored in and implemented in, for example, firmware of the field device 704.

When the FDI host 702 connects to the field device 704, the FDI host 702 may first interact with or communicate with the field device 704 (via the web server 711 and the OPC UA interface 712/707) to obtain the user interface programming files 722 and the UI business logic files 724 for use in the UI engine 710 to be implemented at the FDI host 702. This operation is illustrated by the arrow 760. Alternatively, the FDI host 702 may receive or import these files from a separate FDI package (not shown in FIG. 7). In any event, the UI engine 710 then operates the UI rendering engine 722 and executes the UI business logic 724 (using the files or programming obtained from the field device 704 or an FDI device package) to interact with a user and with the field device 704. However, during operation, the UI engine 710 always interfaces with the field device 704 over the communication network 706 via the OPC UA interface 712/707 to obtain device data from and send device or configuration data, read/write requests, etc. to the field device 704. In this case, the field device 704 retains and implements the device data model 732 and the device business logic 734, and the FDI host 702 may interact with the device engine 730 of the field device 704 as needed to implement configuration, read and write operations, etc. as mandated by the user interactions with the UI engine 710 of the FDI host 702. Of course, all interactions between the UI engine 710 and the field device 704 regarding device data take place using an OPC UA information and model and a OPC UA client/server communication architecture provided between the UI engine 710 and the field device 704 by the communication interface 712/707 which is accessed via the web server 711. This architecture enables the FDI host 702 to operate in an on-line environment without needing to use or have an on-line device model, but instead interacts with the actual device engine in the field device 704 to perform configuration of and communications with the field device 704. Likewise, the UI engine files 722 and 724 used by the FDI host 702 can be provided by the device manufacturer in the field device 704 itself (or via an FDI package) and can program these components using well known and easy to implement web programming and communication paradigms, such as HTML, JavaScript and HTTPS.

FIG. 8 illustrates the FDI host 702 of FIG. 7 used in an off-line environment. Here, the FDI host 702 includes the same elements as illustrated in FIG. 7, including the configuration database 714, the UI engine 710 having the UI rendering engine 722 and the UI business logic 724 coupled to the web interface 711 which is coupled to the OPC UA communication interface 712. However, in this case, the UI engine 710 is connected to an off-line device representation 704R of the field device 704 of FIG. 7. The device representation 704R may be stored in and implemented in the FDI host 702 but may also be stored in and executed in any other desired computer or server in, for example, the engineering environment 703 (as is illustrated in FIG. 8).

Additionally, in this case, an FDI package 850 which may be provided by the device manufacturer of the field device 704 of FIG. 7, includes a file server 858 and an off-line device representation or model 860. The file server 858 includes a UI rendering file or programming instructions 862 and UI business logic 864 and the device representation or device engine 860 include a device data model 872 and a set of device business logic 874. The device data model 872 and the device business logic 874 can be of any type or complexity as specified by the device manufacturer and thus can be simple in nature (such as including a standardized PA-DIM), can be medium complexity, such as a vendor specific data model, or can be complex in nature such as a vendor specific device simulation. In some cases, the device data model 872 and device business logic 874 can be based on, can be a subset of, or can include all of the device firmware of the field device 704 of FIG. 7. The FDI package 850 also includes an OPC UA interface 878. The FDI device package 850 may also include attachments 880 and an FLC offline descriptor file 882 which may be provided to and used by the FDI host 702 during operation.

Prior to operation of the FDI host 702 in an off-line configuration (e.g., in a device or plant simulation mode, for example), the FDI package 850 is provided to and downloaded into the engineering environment 703 to create the device representation 704R as including the OPC UA interface 878, the UI file server 858 with the UI rendering files 862 and the UI business logic 864, and as including the device model or device representation 860 including the device data model 872 and the device business logic 874. This operation is illustrated by the arrow 884. Next, as depicted by the arrow 888, the UI engine 710 of the FDI host 702 connects to the field device representation 704R via the web interface 711 and the OPC UA interface 712/878 and obtains the UI rendering and business logic files 862 and 864 in a manner similar to or the same as the manner in which the FDI host 702 of FIG. 7 connects to and obtains these same files from the actual field device 702 in an on-line implementation. Alternatively, the FDI host 702 may obtain the rendering and business logic file 862 and 864 directly from the FDI device package 850. Thereafter, the UI engine 710 uses these files and programs to perform UI rending and UI control and performs communications with respect to the field device representation 704R using the web server 711 and the OPC UA interface 712/878 and so, essentially, operates or communicates with the field device representation 704R as if it were the actual field device 704. Here, the field device representation 704R implements the device data model 872 and the device business logic 874 to simulate the operation of the actual field device 704 and thus enables the FDI host 702 to perform simulated device configuration of the field device 704, reads and writes to the field device 704, and other operations to, for example, create or change one or more device configuration files 816 for or related to the field device 704 in an off-line environment. These configuration files 816 can then be downloaded to the field device 704 or other devices as one or more of the configuration files 816.

As will be understood, the architecture of FIGS. 7 and 8 enable the FDI host 702 to operate essentially the same in both an on-line and an off-line environment, and enables a device manufacturer to provide device data models and device business logic files for use in simulating field device operation at any desired level or complexity and using any desired technology (as the device data model and business logic are executed in a field device or in a field device representation). Still further, this architecture reduces and/or simplifies the programming the device manufacturer needs to perform to create an FDI device package as it enables the device manufacturer to use the OPC UA information model to perform all communications with the FDI host when performing device data manipulation and simulation, but also provides the FDI host with an easy to use and understand UI interface which can be communicated to the FDI host with known web technologies. Likewise, in an on-line situation, the field device manufacturer can create a simpler FDI package as the FDI package does not need to include a device representation or device engine. Instead, the FDI host 702 uses the device engine as executed in the field device.

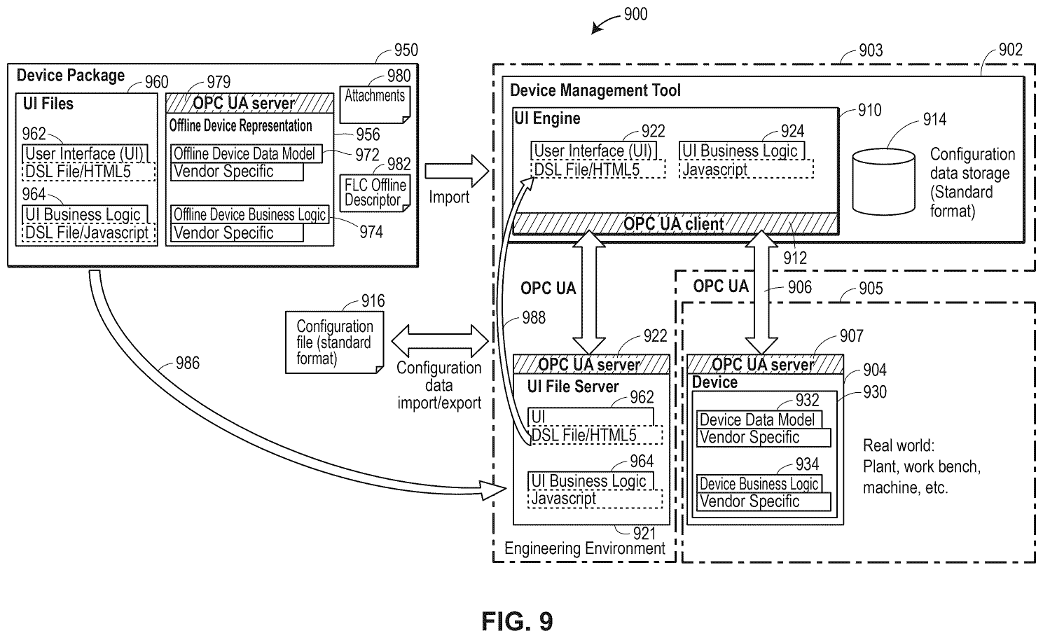

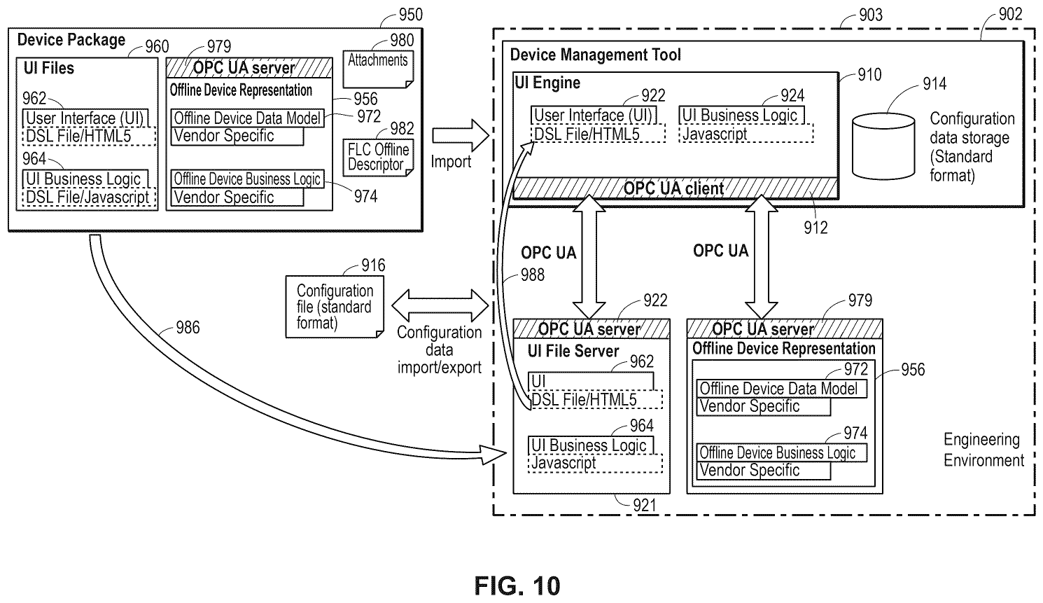

FIGS. 9 and 10, depict a fourth FDI system architecture 900 that, in a manner similar to the architecture of FIGS. 3 and 4, uses an OPC UA client/server communication structure disposed between a field device and/or a field device representation and an FDI host. Here, however, the UI file server and associated UI files are stored in a computer device within the engineering environment in both the on-line and off-line scenarios, while the device engine is stored in the field device in the on-line scenario and is stored in a separate device or server in the off-line scenario. This architecture is useful for supporting simple field devices which may not be able to store or communicate UI files or data to an FDI host, and this architecture simplifies UI support for the field device as provided by the FDI host. Here, the UI engine may be implemented in the FDI host using a traditional web rendering engine and/or a universal programming language such as HTML and JavaScript, or using DSL based files. Likewise, the FDI host performs both UI related communications and device data model related communications using an OPC UA client server/architecture and OPC based communications. Additionally, the FDI host communicates with a UI file server disposed in a computer in an engineering environment for UI based interactions in both on-line and off-line implementations, while the FDI host communicates with a field device for device model manipulation activities in an on-line implementation and communicates with another server implementing a device representation to simulate field device interactions in an off-line implementation. Again, the FDI host, in this embodiment, only needs to include or implement a UI engine that communicates with the field device and with a separate UI file server (in an on-line embodiment) or that communicates with a field device representation or model and a separate UI file server (in the off-line implementation), all using an OPC UA client/server architecture. In this case, the field device only includes the device engine (typically in firmware of the field device) and the field device representation only needs to include the device engine that performs device simulation.

More particularly, FIG. 9 illustrates an FDI system 900 configured using this fourth architecture in an on-line environment. In this case, an FDI host or management tool 902 disposed in an engineering environment 903 is connected to a field device 904 (operating on-line in a real-world environment 905, such as in a plant or factory) via a communication network 906. As will be understood, the field device 904 is compliant with or supports an OPC UA communication interface 907 (or other communication interface that uses an open information model to model device parameters and information). In this case, the FDI host 902 includes a UI engine 910 coupled to or implemented as part of a OPC UA client device with an OPC UA communication interface 912 (or other communication interface that uses an information model to model device parameters and information). The UI engine 910 communicates through the communication interface 912 and the communication network or link 906 to the OPC UA server interface 907 which is within or part of the field device 904. In this manner, the UI engine 910 communicates directly with the field device 904 via the OPC UA server/client interface 912/907 to receive device data and other device information from the field device 904, to send configuration data, read requests, write requests and other parameters or instructions, etc., to the field device 904, etc., using an OPC UA communication paradigm. However, as illustrated in FIG. 9, the UI engine 910 may also communicate, via the OPC UA interface 912, with a UI file server 920 disposed within a further or different computer device 921 in the engineering environment 903, wherein the further device 921 implements an OPC UA server with an OPC UA communication interface 922. As illustrated in FIG. 9, the FDI host 902 also includes a memory or data storage 914 which may store configuration data, etc. in any standard format. The FDI host 902 may also import and/or may create and export one or more configuration files 916 to store configuration and other information in the data storage 914 or to export configuration data from the data storage 914. Of course, the UI engine 910 may interface with the data storage 914 to obtain data therefrom and to store data thereto.

As illustrated in FIG. 9, the UI engine 910 of the FDI host 902 also includes a set of UI rendering instructions or programing 922 and a set of UI business logic 924. In this case, the UI engine 910 may include UI rendering programming 922 implemented as one or more DSL files or using a well-known web rendering paradigm, such as HTML (e.g., HTML5) for rendering. The UI engine 910 may also use any desired programming language, such as java script, to implement the UI business logic. The UI programming 922 and the UI business logic 924 may be provided from the UI file server 921 via the OPC UA interface 912/922. Additionally, the field device 904 includes a device engine 930 which includes a device data model 932 and device business logic 934 stored in and implemented in, for example, firmware of the field device 904.

As also illustrated in FIG. 9, a device manufacturer may provide a device package 950 for use in supporting the FDI host 902 in both on-line and off-line implementations. Here the device package 950 includes an off-line device representation 956 and a set of UI server files 960 including UI rendering files or programming instructions 962 and UI business logic 964. The off-line device representation or device engine 956 includes a device data model 972 and a set of device business logic 974. The device data model 972 and the device business logic 974 can be of any type or complexity as specified by the device manufacturer and thus can be simple in nature (such as including a standardized PA-DIM), can be medium complexity, such as a vendor specific data model, or can be complex in nature such as a vendor specific device simulation. In some cases, the device data model 972 and device business logic 974 can be based on, can be a subset of, or can include all of the device firmware of the field device 904. The off-line device representation 956 also includes an OPC UA interface 979. The FDI device package 950 may also include attachments 980 and an FLC offline descriptor file 982 which may be provided to and used by the FDI host 902 during operation. Here it should be noted that, if the FDI host 902 is used to support the field device 904 only in an on-line environment or implementation, the device package 950 need not include the device representation 956.

Prior to implementation of the FDI host 902 in an on-line implementation, as illustrated by the arrow 986, the device package 950 may be provided to the engineering environment 903 and the UI files 962, 964 within the file server 960 may be provided to or downloaded to the UI file server 921 in the engineering environment 903. Likewise, the attachments 980 and the FLC off-line descriptor 982 may be provided to the FDI host 902 for storage in, for example, the configuration database 914 and for use by the FDI host UI engine 910.

Next, prior the FDI host 902 connecting to the field device 904, as illustrated by the arrow 988, the FDI host 902 may first interact with or communicate with the UI file server 921 in the engineering environment 903 using the OPC UA client/server 912/922 and may then upload or obtain the UI programming files 962 and UI business logic 964 for use as the elements 922 and 924 in performing UI rendering and field device interactions within the FDI host 902. Of course, the FDI host 902 may receive these files 962 and 964 directly from the FDI package 950. In any event, thereafter, the FDI host 902 may interact with or communicate with the field device 904 (via the OPC UA interface 912/907) to obtain information from, send information and requests to, and otherwise interact with the field device 904. Thus, as illustrated in FIG. 9, the UI engine 910 operates a UI rendering engine 922 and executes the UI business logic 924 (using the rendering programming files 962 and business logic programming 964 obtained from the UI file server 921) to interact with a user and with the field device 904. However, during operation, the UI engine 910 always interfaces with the field device 904 over the communication network 906 via the OPC UA interface 912/907 to obtain device data from and to send device or configuration data, read/write requests, etc. to the field device 904. In this case, the field device 904 retains and implements the device data model 932 and the device business logic 934, and the FDI host 902 may interact with the device engine 930 of the field device 904 as needed to implement configuration, read and write operations, etc. as mandated by the user interactions with the UI engine 910 of the FDI host 902. Of course, all interactions between the UI engine 910 and the field device 904 regarding device data take place using an OPC UA information model and a OPC UA client/server architecture provided between the UI engine 910 and the field device 904 by the communication interface 912/907. This architecture enables the FDI host 902 to operate in an on-line environment without needing to use or have an on-line device model, but instead interacts with the actual device engine 930 within the field device 904 to perform configuration of and communications with the field device 904. Likewise, the UI engine files 922 and 924 used by the FDI host 902 can be provided by the device manufacturer via the device package 950 and the manufacturer can program these components using well known and easy to implement web programming and communication paradigms, such as HTML, JavaScript and HTTPS and/or other more specialized paradigms, such as DSL files and DSL rendering engines.

FIG. 10 illustrates the FDI host 902 of FIG. 9 used in an off-line environment. The only difference with the implementation of FIG. 9 is that, instead of communicating with an actual field device 904, the FDI host 902 communicates with a field device representation 904R, which may be located in the engineering environment 903. The field device representation 904R includes a device model 930 including a device data model 972 and device logic or device model business logic 974 obtained from the FDI package 950. As noted above, the device data model 972 and the device business logic 974 can be of any type or complexity as specified by the device manufacturer.

Prior to operation of the FDI host 902 in an off-line configuration (e.g., in a device or plant simulation mode, for example), as illustrated by the arrow 986, the FDI package 950 is provided to and downloaded into the engineering environment 903 to create both the UI file server 921 (including the UI rendering files 962 and the UI business logic 964) and the device representation 904R including the OPC UA server interface 979 and the device engine 956 having the device data model 972 and the device business logic 974. Next, as illustrated by the arrow 988, the UI engine 910 of the FDI host 902 connects to the UI file server 921 via the OPC UA interface 912/922 and obtains the UI rendering and business logic files 962 and 964 in a manner similar to or the same as the FDI host 902 of FIG. 9 connects to and obtains these same files from the same UI file server 921 of FIG. 9. Of course, the off-line device representation 956 may be stored and executed in the FDI host 902 or in a different device and both the device representation 956 and UI engine comprising the UI rending files 962 and UI business logic 964 can be provided directly to the FDI host 902 from the FDI device package 950. Thereafter, the UI engine 910 uses these files or programs to perform UI rending and UI control and performs communications with respect to the field device representation 956 using the OPC UA interface 912/979 and so, essentially, operates or communicates with the field device representation 956 as if it were the actual field device 904. Here, the field device representation 956 implements the device data model 972 and the device business logic 974 to simulate the operation of the actual field device 904 and thus enables the FDI host 902 to perform simulated device configuration of the field device 904, reads and writes to the field device 904, and other operations to, for example, create or change one or more device configuration files 916 for or related to the field device 904 in an off-line environment. These configuration files 916 can then be downloaded to the field device 904 or other devices as one or more of the configuration files 916.

As will be understood, the architecture of FIGS. 9 and 10 enable the FDI host 902 to operate essentially the same in both an on-line and an off-line environment, and enables a device manufacturer to provide device data models and device business logic files for use in simulating field device operation at any desired level or complexity (thereby providing device model scalability) and using any desired technology (as the device data model and business logic are executed in a field device or in a field device representation). Still further, this architecture reduces and/or simplifies the programming the device manufacturer needs to perform to create an FDI device package as it enables the device manufacturer to use the OPC UA information model to perform all communications with the FDI host when performing device data manipulation and simulation, but also provides the FDI host with an easy to use and understand UI interface which can be communicated to the FDI host. Likewise, in an on-line situation, there is no need for the field device manufacturer to create an FDI package that includes a device simulation or device model, as the device engine is executed in the field device as normal.

When implemented in software, any of the applications, services, and engines described herein may be stored in any tangible, non-transitory computer readable memory such as on a magnetic disk, a laser disk, solid state memory device, molecular memory storage device, or other storage medium, in a RAM or ROM of a computer or processor, etc. Although the example systems disclosed herein are disclosed as including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the example systems described herein are described as being implemented in software executed on a processor of one or more computer devices, persons of ordinary skill in the art will readily appreciate that the examples provided are not the only way to implement such systems.

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention. Further, although the forgoing text sets forth a detailed description of numerous different embodiments, it should be understood that the scope of the patent is defined by the words of the claims set forth at the end of this patent and their equivalents. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims and all equivalents thereof.

What is claimed:

1. A device integration system for use in supporting a target device in an offline manner, the device integration system comprising:
a device package stored on a computer readable medium, the device package including a user interface having user interface rendering programing and user interface logic and the device package further including an offline device representation including an offline device model and offline device operational logic for the target device;
a host system including one or more computer readable memories, one or more processors and a graphical user interface terminal, the host system further including;
(1) an offline device engine that uses the offline device representation including the offline device model and the offline device operational logic for the target device as provided by the device package to simulate the operation of the target device,
(2) a user interface engine stored in the computer readable medium and implemented on the processor to enable a user to communicate with the offline device engine for the target device, wherein the user interface engine uses the user interface rendering programming provided by the device package to render images on the graphical user interface terminal and uses the user interface logic provided by the device package to control the operation of the user interface engine for communicating with the offline device engine for the target device; and
(3) a communication interface coupled to the user interface engine implemented on the processor that implements a communication paradigm that uses an extensible information model that models device data from multiple different devices, wherein the communication interface communicates using the communication paradigm;
wherein the user interface engine of the host device communicates with the offline device engine of the target device via the communication interface and the communication paradigm to implement offline operation of the host system.

2. The device integration system of claim 1, wherein the offline device engine is programmed using an a EDDL (Electronic Device Description Language).

3. The device integration system of claim 1, wherein the offline device engine is programmed using a unified Process Automation Device Information Model (PA-DIM).

4. The device integration system of claim 1, wherein the offline device engine is programmed using an Open Platform Communications United Architecture (OPC-UA).

5. The device integration system of claim 1, wherein the host system includes a first processor that executes the user interface engine and a second processor that executes the offline device engine.

6. The device integration system of claim 1, wherein the host system further includes a web server, and wherein the user interface engine uses web-based programming and a web based communication paradigm, wherein the host system communicates via the communication interface with the offline device engine using both the web server and the communication paradigm.

7. The device integration system of claim 1, wherein the host system further includes a web server, and wherein the user interface engine uses web-based programming and a web-based communication paradigm, wherein the user interface engine communicates with the offline device engine via both the web server and the communication interface, wherein the web server uses the web-based communication paradigm to communicate with the communication interface, and the communication interface communicates with the offline device engine using the communication paradigm.

8. The device integration system of claim 1, wherein the host system includes a first processing device that implements the user interface engine and a second processing device that implements the offline device engine, wherein the user interface engine within the first processing device communicates with the offline device engine in the second processing device using the communication interface and the communication paradigm to perform offline activities with respect to the target device.

9. The device integration system of claim 1, wherein the host system stores one or more target device configuration files in a standardized format.

10. The device integration system of claim 1, wherein the host system creates one or more target device configuration files when operating to communicate with the offline device engine and stores the one or more target device configuration files in a standardized format.

11. The device integration system of claim 10, wherein the host system provides the one or more target device configuration files to a further computer device via a further communication interface.

12. A method for performing device communication and configuration activities with respect to a target device via an external communication link, the target device including a device engine having a device model and device operational logic, wherein the device engine implements the device operational logic using the device model to control interactions with the target device, the method comprising:
storing a device package on a computer readable medium, the device package including a user interface having user interface rendering programing and user interface logic and the device package further including an offline device representation including an offline device model and offline device operational logic for the target device;
providing the device package to a host system including a computer readable memory, a processor and a graphical user interface terminal;
executing an offline device engine on the host system, wherein the offline device engine uses the offline device representation including the offline device model and the offline device operational logic for the target device as provided by the device package to simulate the operation of the target device,
executing a user interface engine on the host system to enable a user to communicate with the target device and with the offline device engine for the target device, wherein the user interface engine uses the user interface rendering programming provided by the device package to render images on the graphical user interface terminal and uses the user interface logic provided by the device package to control the operation of the user interface engine;
communicating between the user interface engine of the host system and the target device during on-line operation of the target device via an external communication link using a communication paradigm that uses an information model that models field device data from multiple different field device communication protocols and that communicates using the communication paradigm over the external communication link to perform communication and configuration activities on the target device; and
communicating between the user interface engine of the host system and the offline device engine of the host system during offline operation of the target device using a communication paradigm that uses an information model that models field device data from multiple different field device communication protocols and that communicates using the communication paradigm to perform communication and configuration activities with respect to the target device during offline operation of the host system.

13. The method of claim 12, including executing both the user interface engine and the offline device engine in a single processor of the host system.

14. The method of claim 13, including executing the user interface engine in a first processor of the host system and executing the offline device engine in a second and different processor of the host system.

15. The method of claim 12, further including using a web-based programming and a web-based communication paradigm to implement the user interface of the host system, and further including communicating with the device engine within the target device using the communication paradigm and communicating with the another element of the target device using a web-based server.

16. The method of claim 12, including using web-based programming and a web-based communication paradigm to implement the user interface of the host system, and communicating with the device engine within the target device via both a web-based communication paradigm and the communication paradigm.

17. The method of claim 16, including communicating between the user interface of the host system and a communication interface in the host system using a web-based communication paradigm and communicating between the communication interface of the host system and the target device using the communication paradigm.

18. The method of claim 17, further including tunnelling web-based messages through the communication interface using the communication paradigm.

19. The method of claim 12, including using web-based programming and a web-based communication paradigm to implement the user interface of the host system, and communicating with the device engine within the target device and the offline device engine of the host system via both a web-based communication paradigm and the communication paradigm.

20. The method of claim 12, including creating one or more target device configuration files when operating to communicate between the user interface engine and the offline device engine and storing the one or more target device configuration files in a standardized format in the host system.

21. A method for performing device communication and configuration activities with respect to a target device in an offline manner, the method comprising:
storing a device package on a computer readable medium, the device package including a user interface having user interface rendering programing and user interface logic and the device package further including an offline device representation including an offline device model and offline device operational logic for the target device;
providing the device package to a host system including a computer readable memory, a processor and a graphical user interface terminal;
executing an offline device engine on the host system, wherein the offline device engine uses the offline device representation including the offline device model and the offline device operational logic for the target device as provided by the device package to simulate the operation of the target device,
executing a user interface engine on the host system to enable a user to communicate with the offline device engine for the target device, wherein the user interface engine uses the user interface rendering programming provided by the device package to render images on the graphical user interface terminal and uses the user interface logic provided by the device package to control the operation of the user interface engine;
communicating between the user interface engine of the host system and the offline device engine of the host system during offline operation of the target device using a communication paradigm that uses an information model that models field device data from multiple different field device communication protocols and that communicates using the communication paradigm to perform communication and configuration activities with respect to the target device during offline operation of the host system.

22. The method of claim 21, wherein the offline device engine is programmed using an a EDDL (Electronic Device Description Language).

23. The method of claim 21, wherein the offline device engine is programmed using a unified Process Automation Device Information Model (PA-DIM).

24. The method of claim 21, wherein the offline device engine is programmed using an Open Platform Communications United Architecture (OPC-UA).

25. The method of claim 21, including executing the user interface engine on a first processor of the host system and executing the offline device engine on a second processor of the host system.

26. The method of claim 21, including causing the user interface engine to use web-based programming and a web based communication paradigm, and communicating between the user interface engine and the offline device engine using both the web-based communication paradigm and the communication paradigm.

27. The method of claim 21, including causing the user interface engine to use web-based programming and a web-based communication paradigm, communicating between the user interface engine and the offline device engine via both the web-based communication paradigm and the communication paradigm including using the web-based communication paradigm to communicate between the user interface engine of the host system and a communication interface, and communicating between the communication interface and the offline device engine using the communication paradigm.

28. The method of claim 21, including creating at the host system one or more target device configuration files when the user interface engine operates to communicate with the offline device engine and storing the one or more target device configuration files in a standardized format in the host system.
